(19) United States
(12) Patent Application Publication
(10) Pub. No.: US 2026/0107252 A1
(43) Pub. Date: Apr. 16, 2026

(54) SUPPORTING RELAY NODE ASSISTED POSITIONING

(71) Applicant: InterDigital Patent Holdings, Inc., Wilmington, DE (US)

(72) Inventors: Jaya Rao, Montreal (CA); Fumihiro Hasegawa, Westmount (CA); Oumer Teyeb, Montreal (CA); Tao Deng, New York, NY (US); Tuong Duc Hoang, Montreal (CA); Moon-il Lee, Melville, NY (US); Paul Marinier, Brossard (CA); Martino M. Freda, Laval (CA); Kunjan Shah, London (GB)

(73) Assignee: InterDigital Patent Holdings, Inc., Wilmington, DE (US)

(21) Appl. No.: 19/116,571

(22) PCT Filed: Sep. 28, 2023
(86) PCT No.: PCT/US2023/034012

§ 371 Date: Mar. 28, 2025

Related U.S. Application Data
(60) Provisional application No. 63/410,799, filed on Sep. 28, 2022.

(51) Int. Cl. H04W 64/00; H04B 17/318; H04L 5/00; H04W 56/00

(52) U.S. Cl. CPC H04W 64/00; H04B 17/328; H04L 5/0051; H04W 56/0045

(57) ABSTRACT

Systems, methods, and instrumentalities may be configured for supporting relay node assisted positioning. A first wireless transmit/receive unit (WTRU) may receive, from a network node, configuration information indicating a Sounding Reference Signal for positioning (SRSp) configuration. The SRSp configuration may be associated with a second WTRU, a reference Timing Advance (TA) value associated with the first WTRU, a first threshold value, and a second threshold value. The first WTRU may receive, from the second WTRU, a first RSRP measurement. The first WTRU may determine a first TA value associated with the second WTRU, wherein the determination of the first TA value is based on the first RSRP measurement, the reference TA value, and a measurement associated with the network node. The first WTRU may transmit to the second WTRU, the SRSp configuration and the first TA value for the second WTRU.

### CROSS REFERENCE TO RELATED APPLICATIONS

This application claims the benefit of U.S. Provisional Patent Application No. 63/410,799, filed Sep. 28, 2022, the contents of which are hereby incorporated by reference herein.

### BACKGROUND

Mobile communications using wireless communication continue to evolve. A fifth generation of mobile communication radio access technology (RAT) may be referred to as 5G new radio (NR). A previous (legacy) generation of mobile communication RAT may be, for example, fourth generation (4G) long term evolution (LTE).

### SUMMARY

Systems, methods, and instrumentalities may be configured for supporting relay node assisted positioning. A first wireless transmit/receive unit (WTRU) may receive, from a network node, configuration information indicating a Sounding Reference Signal for positioning (SRSp) configuration. The SRSp configuration may be associated with a second WTRU, a reference Timing Advance (TA) value associated with the first WTRU, a first threshold value, and a second threshold value. The first WTRU may receive, from the second WTRU, a first RSRP measurement. The first WTRU may determine a first TA value associated with the second WTRU, wherein the determination of the first TA value is based on the first RSRP measurement, the reference TA value, and a measurement associated with the network node. The first WTRU may transmit to the second WTRU, the SRSp configuration and the first TA value for the second WTRU.

The first WTRU may receive, from the second WTRU, a second RSRP measurement. The first WTRU may send an indication to the second WTRU based on the first RSRP measurement and the second RSRP measurement.

If a difference between the first RSRP measurement and the second RSRP measurement is between the first threshold value and the second threshold value, the first WTRU may determine a second TA value for the second WTRU to use in association with SRSp transmission. The determination of the second TA value may be based on the first RSRP measurement, the second RSRP measurement, and the first TA value.

The first WTRU may transmit to the second WTRU, the indication, and the indication may indicate the second TA value. If a difference between the first RSRP measurement and the second RSRP measurement is above the second threshold value, the first WTRU may transmit to second WTRU, the indication. The indication may indicate to release the SRSp configuration.

The first RSRP measurement may be associated with a Transmission Reference Point (TRP), and the second RSRP measurement may be associated with the TRP. The first TA value may indicate a timing advance associated with SRSp transmission by the second WTRU. The first WTRU may include a relay WTRU, and the second WTRU may include a target WTRU.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 illustrates an example of a position reference signal (PRS) configuration hierarchy.

FIG. 3 illustrates an example of zone-area-specific positioning.

FIG. 4 illustrates an example wherein a relay WTRU may trigger the activation/deactivation of SRSp transmission at a target WTRU.

FIG. 5 illustrates an example wherein a relay WTRU may assist with hybrid positioning.

FIG. 6 illustrates an example wherein a relay WTRU may forward an SRSp configuration.

### DETAILED DESCRIPTION

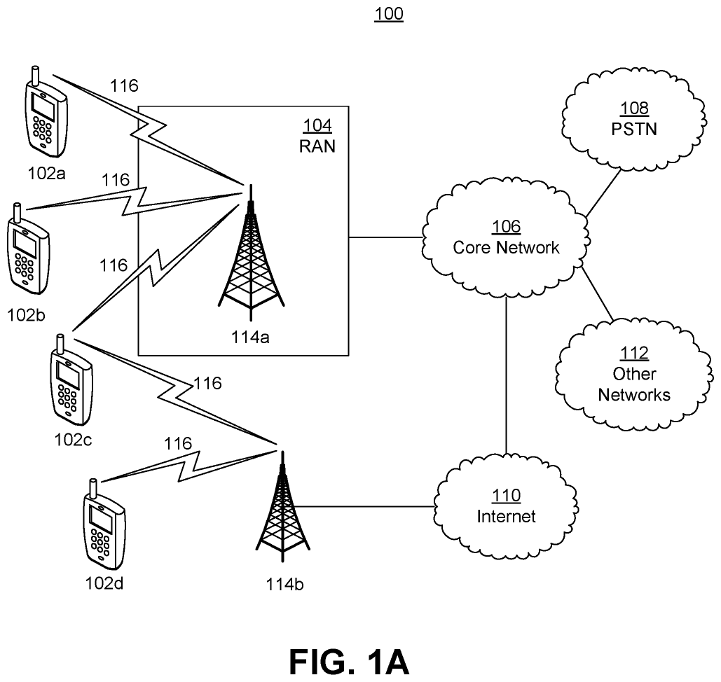

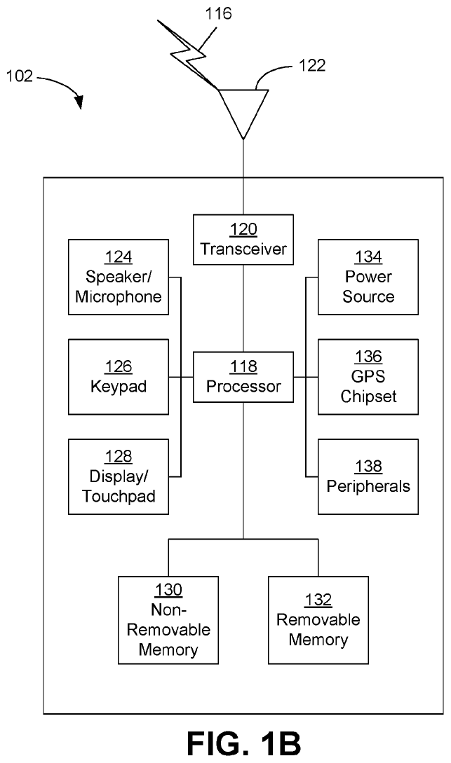

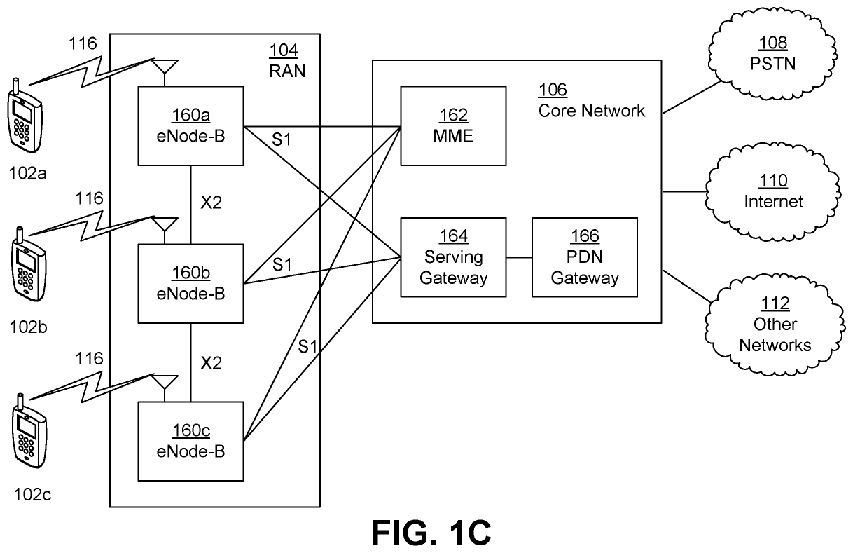

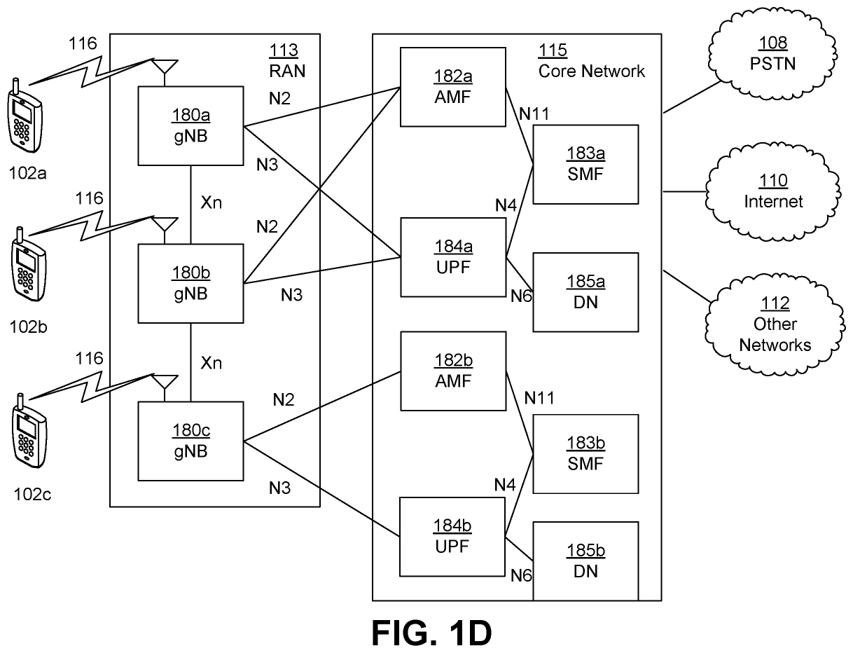

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. In examples, the communications systems 100 may employ one or more channel access techniques, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. In examples, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. In examples, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. In examples, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. In examples, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VOIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. In examples, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. In examples, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). In examples, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. In examples, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134 and may be configured to distribute and/or control the power to the other components in the WTRU 102. The power source 134 may be any suitable device for powering the WTRU 102. In examples, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination technique while remaining consistent with an embodiment.

The processor 118 may further be coupled to other peripherals 138, which may include one or more software and/or hardware modules that provide additional features, functionality and/or wired or wireless connectivity. In examples, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the uplink (UL) (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUS 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. In examples, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. In examples, the CN 106 may provide the WTRUs 102a, 102b, 102c with access to circuit-switched networks, such as the PSTN 108, to facilitate communications between the WTRUs 102a, 102b, 102c and traditional land-line communications devices. In examples, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily, or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. In examples, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. In examples, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. In examples, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. In examples, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. In examples, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. In examples, the AMF 182a, 182b may be responsible for authenticating users of the WTRUs 102a, 102b, 102c, support for network slicing (e.g., handling of different Packet Data Unit (PDU) sessions with different requirements), selecting a particular SMF 183a, 183b, management of the registration area, termination of Non-Access Stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. In examples, different network slices may be established for different use cases such as services relying on ultra-reliable low latency communications (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. In examples, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. In examples, the emulation devices may be used to test other devices and/or to simulate network and/or WTRU functions.

The emulation devices may be designed to implement one or more tests of other devices in a lab environment and/or in an operator network environment. In examples, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may perform testing using over-the-air wireless communications.

The one or more emulation devices may perform the one or more, including all, functions while not being implemented/deployed as part of a wired and/or wireless communication network. In examples, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

As described herein, examples may support relay assisted positioning. In examples, a target WTRU to be positioned may be located at a cell edge, in poor coverage, or out-of-coverage (OOC) scenarios. In examples, a target WTRU may not have assistance data/resources (e.g., Sounding Reference Signal (SRSp) configurations and/or Position reference Signal (PRS) configurations) for supporting Uu-based positioning. In examples, a target WTRU may have connectivity to a network via one or more relay WTRUs.

In examples, a sidelink (SL) relay WTRU may be used to support/assist positioning of a target WTRU.

A relay WTRU may assist with triggering of UL-SRSp transmission at a target WTRU. In examples, a relay WTRU may be configured to receive configuration information from a network, including: SL distance threshold+other triggering conditions (e.g., based on Round Trip Time (RTT)), UL-SRSp configuration associated with Reception Points (RPs), and one or more validity conditions associated with UL-SRSp configuration (e.g., TA timer at relay WTRU). A relay WTRU may be configured to perform measurements over SL (e.g., Reference Signal Received Power (RSRP) or RTT measurements of SL-PRS or SL channels) and determine a distance to a target WTRU based on SL measurements. If a distance to a target WTRU is above an SL distance threshold, and the one or more validity conditions are met (e.g., TA timer at relay WTRU is running), the relay WTRU may be configured to transmit to a target WTRU the UL-SRSp configuration associated with RPs, transmit an indication to gNB on triggering SRSp transmission at target WTRU, transmit to a target WTRU an SRSp activation indication (e.g., in SL MAC Control Element (CE), and if an SRSp is previously activated and validity condition is not met (e.g., TA timer at relay WTRU is expired), transmit to a target WTRU an SRSp deactivation indication.

A relay WTRU may assist triggering of an SRSp and SL-PRS transmission at a target WTRU. In examples, a relay WTRU may be configured to do the following. A relay WTRU may be configured to receive configuration information from the Network (NW). The configuration information may include an SL-PRS configuration intended for target WTRU, a UL-SRSp configuration associated with RPs, a first threshold (e.g., a Reference Signal Receive Power (RSRP) threshold, threshold1, and/or an upper bound) and a second threshold (e.g., threshold 2 and/or a lower bound). The relay WTRU may be configured to transmit to a target WTRU an SL-PRS configuration (e.g., via PC5 signaling (PC5)-Radio Resource Control (RRC)), including timing information. The relay WTRU may be configured to receive (e.g., receive from the target WTRU) RSRP measurements of SSB of a serving cell as determined by the target WTRU. If the target WTRU's RSRP measurements are below a first threshold and above a second threshold (e.g., the target WTRU has a poor Uu link with serving cell), the relay WTRU may be configured to transmit to the target WTRU an SL-PRS activation indication (e.g., in SL MAC Control Element (MAC CE)), perform measurements of the SL-PRS received from the target WTRU, and transmit to the network a measurement report, including a time of arrival (e.g., a timestamp) and an RSRP measurement of the SL-PRS. If the target WTRU's RSRP measurements are below the second threshold (e.g., the target WTRU has no Uu link), the relay WTRU may be configured to transmit to the target WTRU the UL-SRSp configuration associated with RPs, transmit an indication to a gNB on triggering the SRSp and SL-PRS transmission at the target WTRU, transmit to the target WTRU an SRSp activation indication and SL-PRS activation indication (e.g., in SL MAC CE), and transmit to the network a measurement report including the time of arrival (e.g., a timestamp) and an RSRP measurement of the SL-PRS.

Downlink, uplink, sidelink, and downlink, uplink, and sidelink positioning techniques may be used.

In examples including downlink positioning, a PRS may be sent from multiple Transmission-Reception Points (TRPs), and the PRS may be sent to the WTRU. The WTRU may observe multiple reference transmissions and measure a time difference of arrival (TDoA) between one or more (e.g., a pair of) PRSs. The TDoA may be referred to as a Received Signal Time Difference (RSTD). The WTRU may send the measured RSTD to an Location Management Function (LMF). The WTRU may send a measured RSRP for a PRS (e.g., each PRS). Based at least on the returned measurements, the LMF may conduct positioning of the WTRU. The WTRU may report the RSRP for DL angle-based positioning techniques.

An LMF may be a non-limiting example of a node or entity (e.g., a network node or entity) that may be used for or to support positioning. A node or entity may be substituted for an LMF.

In examples including uplink positioning, the WTRU may send the SRS for positioning (e.g., the SRS configured by RRC for positioning) to TRPs. In examples that are timing-based, the TRP may measure Relative Time of Arrival (RTOA) for the received SRS and report measured values to the LMF. The WTRU may report the RSRP for the SRS. In angle-based uplink positioning, the TRP may measure angles of arrival and report to the LMF.

In examples including uplink and downlink positioning, the WTRU may measure an Rx-Tx time difference between the received PRS and the SRS transmitted. The WTRU may report the Rx-Tx time difference may to an LMF. The WTRU may report measured RSRP for PRS. At the TRP, an Rx-Tx difference between the received SRS and transmitted PRS may be computed.

Positioning may be described herein. DL positioning may include positioning that uses downlink reference transmissions such as PRS. The WTRU may receive multiple reference transmissions from the TP and may measure DL RSTD and/or RSRP. Examples of DL positioning may include one or more of DL-Angle of Departure (AoD) or DL-TDOA positioning.

UL positioning may include positioning that may use uplink reference transmissions (e.g., such as SRS for positioning). The WTRU may transmit an SRS to multiple RPs, and the RPs may measure the UL RTOA and/or RSRP. Examples of UL positioning techniques may include UL-TDOA or UL-Angle of Arrival (AoA) (UL-AOA) positioning.

SL positioning may include positioning and/or ranging that may use sidelink reference transmissions such as an SL-PRS for positioning/ranging. In examples, a WTRU (e.g., a target WTRU) may transmit the SL-PRS to one or more other WTRUs (e.g., anchor WTRUs, RSUs), and (e.g., the other) WTRUS may measure the SL RTOA and/or the SL RSRP. A WTRU may receive the SL-PRS from one or more WTRUs (e.g., anchor WTRUs, RSUs), and the WTRU may measure the SL RTOA and/or SL RSRP. Examples of SL positioning may include one or more of SL-TDOA, SL-AoA, SL-AOD, or SL-based RTT positioning.

DL & UL positioning may include positioning that may use uplink and downlink (e.g., both uplink and downlink) reference transmissions for positioning. In examples, a WTRU may transmit an SRS to multiple TRPs, and a gNB may measure the Rx-Tx time difference. The gNB may measure RSRP for the received SRS. The WTRU may measure Rx-Tx time difference for PRS transmitted from multiple TRPs. The WTRU may measure RSRP for the received PRS. The Rx-TX difference and the RSRP measured (e.g., measured at the WTRU and gNB) may be used to compute a round trip time. The Rx and Tx difference may include the difference between arrival time of the reference transmission transmitted by the TRP and transmission time of the reference transmission transmitted from the WTRU. Example of DL & UL positioning technique may include multi-RTT positioning.

Timing/angle positioning may include a positioning technique that may use reference transmissions such as SL-PRS. The WTRU may receive multiple reference transmissions from WTRU(s) and may measure an RSTD, RSRP, and/or AoA. Examples of angle/timing positioning techniques may include SL-AoD or SL-TDOA positioning. In examples, the WTRU may transmit the SL-PRS to WTRU(s), and the receiver may perform measurements (e.g., RSTD, AoA, RSRP) for determination of the locations of the WTRU that may have transmitted the SL-PRS.

RTT positioning may include positioning that may use two or more WTRUs to transmit the SL-PRS between WTRUs. In examples, an anchor WTRU may transmit the SL-PRS to the target WTRU. The target WTRU may receive the SL-PRS from the anchor WTRU, and the target WTRU may transmit the SL-PRS to the anchor WTRU. The target WTRU may measure a WTRU Tx-Rx time difference (e.g., the difference between transmission time of the SL PRS from the target WTRU and reception time of the SL-PRS transmitted from the anchor WTRU). The target WTRU may report the WTRU Tx-Rx time difference to the anchor WTRU.

Enhanced Cell ID (e-CID) positioning may include a positioning that may use Radio Resource Management (RRM) measurements (e.g., an RSRP of SSB) of cells associated with multiple gNBs. The operation principles for this positioning may be similar to other positioning techniques based on DL reference transmissions (e.g., DL-AoD, DL-TDOA, etc.). The transmissions that may be measured may lead to less accuracy in the positioning determination.

In examples, a network may include an AMF, LMF, base station, TRP or gNB in NG-RAN (next generation radio access network). Positioning utilized for DL-PRS measurements in RRC CONNECTED may allow a limited level of intra-gNB mobility (e.g., within coverage areas of TRPs belonging to the same gNB) and inter-gNB mobility (e.g., for scenarios where the same PRS configuration may be used by multiple gNBs). The reporting of measurements and/or location information to the LMF may be supported via the serving gNB/cell.

In examples, a relay WTRU may include one or more of a WTRU (e.g., any anchor WTRU, any reference WTRU), positioning reference units (PRUs), RSU, IAB node, drone, robot, or network node (e.g., relay node, TRP). A relay WTRU may have use any of the SL interface (e.g., PC5) and Uu interface, for transmission and reception of data/control messages, and reference transmissions (e.g., SL-PRS, SRSp, PRS) over one or more channels. A relay WTRU may operate as an L2 or L3 relay for forwarding positioning related transmissions. A relay WTRU may be stationary or mobile (e.g., moving in a direction and/or with a speed) relative to one or more stationary or mobile WTRUs, and/or other network nodes (e.g., TRPs, gNBs).

WTRU-based and LMF-based (e.g., WTRU-assisted) positioning (e.g., for RAT-dependent and RAT-independent positioning techniques) may be provided. The WTRU behavior and the procedures for supporting positioning may include one or more steps in one or more positioning procedures and may not be limited to reception of broadcast channels, configuration, transmission/reception of initial access messages, transmission/reception of positioning reference transmissions, measurements, and reporting, which may be supported by WTRU with low latency, high reliability, high power savings and high accuracy regardless of coverage scenarios are unknown.

The procedures and transmitting for Uu-interface based positioning may include one or more of a transmission of capability information from the WTRU to the network, a reception of assistance data from network to WTRU, a reception of reference transmissions (e.g., PRS and/or SRSp) by WRTU, or a transmission of reference transmissions (e.g., PRS and/or SRSp) by WRTU. A request for location information and measurement reports may be supported via a combination of high layer transmitting (e.g., LTE Positioning Protocol (LPP)) and AS layer transmitting (e.g., RRC, MAC CE, Downlink Control Information (DCI)). Procedures and transmitting for SL-based positioning may be supported via one or more of high layer transmitting (e.g., SL-LPP, Ranging and Sidelink Positioning Protocol (RSPP)) or AS layer transmitting (e.g., PC5-RRC, SL MAC CE, SCI). The procedures and transmitting for determining the WTRU positioning information with relay WTRUs may be unknown.

In examples, a target WTRU to be positioned may be located at a cell edge, in poor coverage areas (e.g., poor link quality), or out-of-coverage (OOC) of any cells in a network. The target WTRU may not have direct connectivity with the network for receiving positioning resources and/or configurations (e.g., PRS, SRSp, SL-PRS configurations) that may be used for supporting a Uu-based or an SL-based positioning techniques. The target WTRU may have indirect connectivity with the network via a relay WTRU (e.g., multi-hop), where the target WTRU may be connected with a relay WTRU via an SL interface (e.g., PC5, NR SL), and the relay WTRU may be connected with the base station (e.g., via the Uu interface). If the target WTRU is indirectly connected with the network, the target WTRU may need to be positioned with high accuracy (e.g., relatively high accuracy) and low latency.

In DL based positioning, the WTRU may perform measurements of resources associated with DL-PRS and send measurement reports to the LMF based on assistance data provided by the network. In UL-based positioning, the WTRU may be configured with SRS for positioning (SRSp) resources via RRC transmitting. The transmission of the SRSp by the WTRU may be received by different TRPs/gNBs (e.g., in the network) for performing positioning measurements and reporting of the measurements to the LMF and determining the WTRU location. Such positioning that may allow for determining the location of WTRU with certain accuracy may be performed (e.g., may need to be performed) with the knowledge that the target WTRU may be accessible by the network or vice-versa via one or more relay WTRUS.

In examples involving relaying, the LMF may not be aware that the target WTRU may be indirectly connected to the network via a relay WTRU. The LMF may provide assistance data (e.g., PRS configurations, location information of TRPs/cells) that may not be suitable for positioning the target WTRU. The relay WTRU (e.g., L2 relay) that may be used for the purpose of relaying data may not be aware that the target WTRU may be supporting positioning procedure and/or may be associated with network (e.g., gNB, LMF) for positioning. This may result in higher latency or incorrect triggering of certain positioning procedures (e.g., SRSp transmission) when the target WTRU is dynamically controlled by the network. The target WTRU may be served by a relay WTRU and may not be aware of the timing information (e.g., System Frame Number (SFN) of the relay WTRU's serving cell. This may result in timing misalignments during PRS reception and/or SRSp transmissions. Since the target WTRU to be positioned may be located in poor or OOC areas with respect to the serving cell of the relay WTRU, positioning the target WTRU with high accuracy may be challenging.

It may be determined how the SL relay WTRU may be used to support and/or assist the positioning of a target WTRU.

In examples, positioning may be provided. In examples, SRS for positioning as stated herein may refer to an SRS transmission used for positioning. Resources for SRS for positioning (SRSp) may be defined (e.g., transmitted) using the higher layer (e.g., RRC) messages. SRS resource set(s) and SRS resource(s) configured for positioning may be specified. SRS for positioning or SRS as stated herein may include one or more of the following: an SRS that may be configured under SRS-PosResourceSet-r16 and SRS-PosResource-r16; an SRS that may be configured under SRS-ResourceSet and SRS-Resource; an SRS that may not be configured under SRS-PosResource Set-r16 and SRS-PosResource-r16; an SRS that may not be configured under SRS-ResourceSet and SRS-Resource; an SRS that may not be associated with SRS-PosResourceSet-r16, SRS-PosResource-r16, SR ResourceSet or SRS-Resource; an Uplink reference transmission that may be provided for positioning; a Demodulation Reference Signal (DM-RS) for uplink; or a Phase Tracking Reference Signal (PTRS) for uplink.

SRS for positioning may be denoted as SRSp. PRS or SRS as used herein may not be limited to the Reference Signal (RS) used for positioning. The techniques as described herein may be applied to or used with DL or UL reference transmissions (e.g., any DL or UL reference transmissions).

A positioning configuration may include information related to positioning measurement and/or SRSp transmission. One or more of the following information may be included in a positioning configuration: One or more of the following positioning techniques: DL-TDOA, UL-TDOA, DL-AoD, UL-AoA, Multi-RTT, SL-TDOA, SL-AOA, SL-AOD, or SL-RTT; a PRS configuration; an SRSp configuration; an SL-PRS configuration; an uplink resource (e.g., Physical Random Access Channel (PRACH), Physical Uplink Shared Channel (PUSCH), Physical Uplink Control Channel (PUCCH) to report the positioning measurement; one or more threshold values to determine the positioning measurement quality; or a positioning mode of operation (e.g., a starting positioning mode of operation).

A PRS resource configuration may include one or more of the following: a PRS resource ID; a PRS sequence ID (e.g., or other IDs used to generate a PRS sequence); a PRS resource element offset; a PRS resource slot offset; a PRS symbol offset; a PRS Quasi co-located (QCL) information; a PRS resource set ID; a list of PRS resources in the resource set; a number of PRS symbols; a muting pattern for PRS, muting parameters such as repetition factor, muting options; a PRS resource power; a periodicity of PRS transmission; a spatial direction information of PRS transmission (e.g., beam information, angles of transmission); a spatial direction information of UL Reference Signal (RS) reception (e.g., beam ID used to receive UL RS, angle of arrival); a frequency layer ID; a TRP ID; or a PRS ID.

An SRSp resources configuration may include at least one of the following: a resource ID; comb offset values, cyclic shift values; a start position in a frequency domain; a number of SRSp symbols; a shift in the frequency domain for SRSp; a frequency hopping pattern; a type of SRSp (e.g., aperiodic, semi-persistent or periodic); a sequence ID used to generate SRSp, or other IDs used to generate SRSp sequence; spatial relation information, indicating which reference transmission (e.g., DL RS, UL RS, Channel State Information (CSI)-RS, SRS, DM-RS) or SSB (e.g., SSB ID, cell ID of the SSB) the SRSp may be related to spatially; QCL information (e.g., a QCL relationship between SRSp and other reference transmissions or SSB), QCL type (e.g., QCL type A, QCL type B, QCL type D); a resource set ID; a list of SRSp resources in the resource set; transmission power related information; pathloss reference information which may include an index for SSB, CSI-RS or PRS; a periodicity of SRSp transmission; a spatial direction information of SRSp transmission (e.g., beam information, angles of transmission); or a spatial direction information of DL RS reception (e.g., beam ID used to receive DL RS, angle of arrival).

An SL-PRS configuration may include one or more of the following: an SL-PRS resource ID; an SL-PRS sequence ID (e.g., or other IDs used to generate SL-PRS sequence); an SL-PRS resource element offset; an SL-PRS resource slot offset; an SL-PRS symbol offset; SL-PRS QCL information; an SL-PRS resource set ID; a list of SL-PRS resources in the resource set; a number of SL-PRS symbols; a muting pattern for SL-PRS; muting parameters including a repetition factor; muting options; an SL-PRS resource power; a periodicity of the SL-PRS transmission; spatial direction information of an SL-PRS transmission (e.g., beam information, angles of transmission); spatial direction information of SL-RS reception (e.g., beam ID used to receive SL-RS, angle of arrival); a frequency layer ID; a UE ID; or an SL-PRS ID.

In examples, and as the part of a configuration, the WTRU may receive information related to the cell ID, global cell ID or TRP ID which may be associated with the PRS. The TRP which transmits PRS may be identified by the TRP ID, which may belong to a cell identified by the cell ID. The WTRU may be configured with timing information such as an SFN offset for PRS or SRSp transmission. The offset may be introduced to prevent the WTRU from receiving overlapping PRS in the time domain.

The WTRU may obtain parameters or configurations related to SRSp or SRS in one or more of an RRC, MAC-CE, DCI, or LPP message. The WTRU may obtain the parameters, configurations, or thresholds (e.g., threshold for RSRP) related to SRSp or SRS in a broadcast message (e.g., SIB) or in dedicated transmitting for the WTRU from the network.

As described herein, an SRS and SRSp may be used interchangeably.

As described herein, a target WTRU or remote WTRU may be used interchangeably and may refer to any WTRU that may be positioned with a positioning approach, including absolute positioning (e.g., with global coordinates), relative positioning (e.g., with local coordinates) or ranging (e.g., distance and/or direction with respect to a reference node).

As described herein, a relay WTRU and an anchor WTRU may be used interchangeably. The relay WTRU or the anchor WTRU may refer to a WTRU that may be used for supporting and/or assisting with the positioning of a target WTRU. The target WTRU may be stationary or mobile (e.g., relatively mobile) with respect to any network node (e.g., TRP, gNB, cell) or peer (e.g., another peer) WTRU (e.g., relay WTRU, anchor WTRU) which may be used for positioning. The target WTRU may perform (e.g., any of) PRS measurements, SRSp transmissions and SL-PRS measurements/transmission from/to network node and/or other WTRUs during positioning.

In examples, the relay-WTRU assisted positioning may support the positioning techniques (e.g., DL-based, UL-based, SL-based) for positioning of a target WTRU located in coverage scenarios (e.g., in coverage, partial coverage, out-of-coverage) with the assistance from one or more relay WTRUs. The relay WTRU may be used for forwarding the positioning related transmitting between the network and target WTRU and/or for performing transmissions and/or measurements of positioning reference transmissions (e.g., SRSp, PRS, SL-PRS).

In examples, a target WTRU located in a cell edge, poor coverage, or OOC scenarios may be assisted by one or more relay WTRUs located in coverage for supporting Uu-link based positioning (e.g., DL-TDOA, UL-TDOA), SL-based positioning and/or Uu+SL based positioning. The relay WTRU may be used for extending the coverage of the network (e.g., gNB, LMF) by providing suitable assistance data (e.g., positioning SIB), positioning resources/configurations, and other network configuration/parameters (e.g., timing info, SFN) to the target WTRU for positioning. When the target WTRU is in coverage (IC), the relay WTRU may be used by the target WTRU for receiving and/or transmitting (e.g., transmitting any) positioning related transmitting (e.g., LPP messages) while minimizing overhead over a Uu link and minimizing Tx power.

In examples involving a DL-based positioning, a WTRU may measure DL transmissions (e.g., PRS) received from one or more TRPs. DL-based positioning may be used when the WTRU may be in an (e.g., any) RRC state (e.g., CONNECTED, INACTIVE or IDLE). In examples, the TRPs may transmit the PRS and not a SSB or a SIB that may include transmissions for synchronization and/or assistance data for positioning (e.g., PRS configurations, TRP location information). In examples, the TRPs may transmit PRS, SSBs and/or limited assistance data. In examples, the coverage and transmission quality of the PRS transmitted by the TRPs may be better than the SSB (e.g., due to use of different transmission scheme and/or resources). This may allow the WTRU to receive the PRS but not the SSB. In examples, the WTRU may access the network for receiving positioning assistance data and timing related information (e.g., synchronization, SFN) via the relay WTRU over SL. In examples, the relay WTRU may provide the assistance data to the target WTRU based on (e.g., some) conditions configured by the network. The relay WTRU may be used for forwarding any of the higher layer transmitting (e.g., LCS/LPP/SL-LPP) from the network to the target WTRU. Likewise, the target WTRU may forward positioning information (e.g., measurements reports, calculated WTRU location) to the network via the relay WTRU.

In an example involving UL-based positioning, the WTRU may transmit UL transmissions (e.g., SRSp) that may be measured by one or more TRPs (e.g., reception points (RPs)). The TRPs may transmit (e.g., any) SSBs or provide (e.g., any) positioning configurations/resources (e.g., SRSp configurations) to the WTRU, for example. The WTRU may receive the positioning configurations/resources and timing information (e.g., synchronization, TA) from the network via a relay WTRU over SL. In examples, the relay WTRU may provide the SRSp and/or SL-PRS configurations to the target WTRU and/or dynamically trigger the target WTRU to transmit SRSp/SL-PRS, for example, based on conditions configured by the NW. In examples, the relay WTRU may be configured to perform measurements of SRSp and/or SL-PRS transmitted by the target WTRU. The relay WTRU may transmit the measurement results to NW, which may be used for determining the location of the target WTRU.

Techniques common to the relay WTRU and the target WTRU may support relay WTRU-assisted positioning. In examples, such positioning may be initiated when the target WTRU is connected with the relay WTRU. In examples, a WTRU (e.g., target WTRU or relay WTRU) may be triggered to initiate any of the positioning procedures (e.g., DL-based, UL-based, SL-based, Hybrid Uu+SL based) for positioning a target WTRU. The WTRU target may be connected to one or more relay WTRUs when receiving/detecting a positioning initiation message. The network (e.g., the LMF) may be aware of the connection status of the target WTRU with a relay WTRU when transmitting/receiving a positioning initiation message. The positioning of a target WTRU may be initiated based on any of the following: a triggering/reception of location services (LCS) message, a reception of an LLP request/indication, or WTRU initiation (e.g., target WTRU or relay WTRU).

The positioning of a target WTRU may be initiated based on the triggering/reception of an LCS message. In examples, an LCS client in the WTRU (e.g., for MO-LR) or network/LMF (e.g., MT-LR) may trigger a request for location information of a target WTRU along with an (e.g., implicit, or explicit) indication indicating the use of one or more relay WTRUs for assisting with the positioning of the target WTRU. In examples, an LCS client/network may explicitly indicate to perform positioning of a target WTRU with the assistance of one or more relay WTRUs. In examples, the LCS client/network may implicitly indicate the use of the relay WTRU, when available, when indicating a relaxed latency requirement for positioning or performing positioning when the WTRU is in OOC scenarios, for example. An LCS client/network may implicitly indicate the use of the relay WTRU when providing assistance data including relay WTRU information (e.g., IDs, relay WTRU location info), for example.

The positioning of a target WTRU may be initiated based on a reception of an LPP request/indication. In examples, the WTRU (e.g., target WTRU or relay WTRU) may receive an indication from the network (e.g., LMF, gNB) indicating to switch to a different positioning technique (e.g., from SL-based positioning to Uu-based positioning or vice-versa) when (e.g., some) relay WTRUs may be available/detectable (e.g., to the target WTRU). In examples, such an indication may be received based at least on an indication/message sent by the WTRU (e.g., target WTRU or relay WTRU) to the network informing of one or more of the following: an initial target WTRU location, initial measurements of transmissions/channels over Uu-link (e.g., SSBs, CSI-RS, PRS), initial measurements of transmissions/channels over SL (e.g., SL-SSB, Channel Busy Ratio (CBR), discovery messages, SL-PRS), initial estimation of a timing advance (TA) value at the relay WTRU and/or target WTRU, or detection of one or more relay WTRUs (e.g., IDs) by the target WTRU. In examples, a target WTRU may directly or indirectly connected to the network (e.g., the LMF), and an ongoing LPP session may receive an indication/configuration information to use one or more relay WTRUs for the purpose of positioning (e.g., for performing SRSp/SL-PRS measurements), when the relay WTRUs may be in range of the WTRU (e.g., the target WTRU) may detect (e.g., any) transmissions (e.g., discovery message) from the relay WTRUs).

The positioning of a target WTRU may be WTRU initiated (e.g., the target WTRU or relay WTRU). In examples, the relay WTRU assisted positioning for performing one or more of DL-based, UL-based, or SL-based positioning may be initiated by the target WTRU when the target WTRU is may be in coverage of at least one of the TRPs (e.g., the PRS is detectable) and/or in coverage of a relay WTRU (e.g., when detecting SL transmissions sent by relay the WTRUs or when the RSRP of the SL transmissions may be above/below RSRP threshold values). In examples, a target WTRU preconfigured with (e.g., some) initial PRS configurations may use the configuration for detecting one or more TRPs, and the TRPs may transmit the PRS continuously or periodically. The WTRU may perform initial measurements of the PRS using PRS configurations (e.g., preconfigured PRS configurations) associated with the TRPs. The WTRU may establish connectivity with the network via a relay WTRU (e.g., upon discovery and establishing an SL connection with the relay WTRU). If the PRS measurements satisfy criteria/conditions (e.g., if the ToA/RSRP of the PRS is above a threshold and/or remains above a threshold for some duration), the WTRU may report to the network via the relay WTRU the PRS measurements or location estimate of the WTRU, for example. In examples, the relay WTRU assisted positioning for performing positioning of a target WTRU may be initiated by the relay WTRU when preconfigured to assist positioning of one or more target WTRUs and/or when detecting transmissions sent by the target WTRUs over SL. In examples, a relay WTRU may trigger positioning of a target WTRU by initiating a transmission of positioning related discovery messages and/or positioning assistance data (e.g., posSIB) when conditions (e.g., some conditions) are be met (e.g., a detection of a target WTRU, or RSRP measurements of a Uu link may be within a preconfigured threshold range).

In examples, the WTRU may send capability/assistance information for supporting relay WTRU assisted positioning. A WTRU (e.g., a target WTRU and/or relay WTRU) may send capability/assistance information to one or more of the network (e.g., the gNB or LMF) or WTRU for supporting relay WTRU assisted positioning when detecting one or more triggering events/conditions as described herein. The WTRU may send the capability/assistance information semi-statically before/after initializing positioning procedure (e.g., an LPP session) for determining the location of a target WTRU. The WTRU may send capability/assistance information dynamically or on an on-demand basis at any given time after initializing positioning procedure. The WTRU may send the capability/assistance information to the network in LPP messages (e.g., the LPP may provide capability information or the LPP may provide assistance information message) or AS layer transmitting/messages (e.g., RRC, MAC CE, Uplink Control Information (UCI), PUSCH). In examples, a relay WTRU may send the capability/assistance information to a target WTRU or vice versa over SL using higher layer (e.g., Sidelink LTE Positioning Protocol (SLPP), RSPP) or AS layer transmitting (e.g., PC5-RRC, MAC CE, SCI).

The information sent by a target WTRU and/or relay WTRU as capability information (e.g., via LPP capability transfer procedure, AS layer transmitting/messages) or assistance information (e.g., via LPP assistance data transfer procedure, AS layer transmitting/messages) may include a combination of one or more of the following: positioning techniques; device and timing attributes/parameters; accuracy achievable; transmission measurements/estimations; reference locations, reference time instances, trajectory; or information on power saving modes.

Positioning may include a capability to operate in a WTRU-assisted mode and/or WTRU-based mode for positioning. In examples, the target WTRU may be located in OOC and may indicate the capability to support WTRU-based positioning with the assistance of one or more relay WTRUs. In examples, a relay WTRU may indicate the capability to assist a target WTRU for positioning and/or estimate location of a target WTRU when operating in WTRU-based or WTRU-assisted mode. The relay WTRU may indicate the capability to estimate the location of a target WTRU with limited PRS/SL-PRS measurements and/or SRSp/SL-PRS transmissions or without performing PRS/SL-PRS measurements and/or SRSp/SL-PRS transmissions, for example, based on a positioning delegation technique (e.g., the target WTRU location information may be estimated or represented by the relay WTRU location info. Positioning may include type of nodes. In examples, the WTRU may indicate the one or more identifiers/information associated with the node types (e.g., TRPs/gNBs, PRUs, relay WTRUs, IAB nodes) or node attributes (e.g., stationary, or mobile) which may be used for performing positioning measurements and/or transmissions. In examples involving positioning, the WTRU may indicate the identifiers/information on the positioning that may be used, including Uu-based, SL-based and hybrid Uu+SL (e.g., DL-TDOA, UL-TDOA, UL-AOA, multi-RTT, SL-TDOA, SL-RTT, e-CID, etc.).

Device and timing attributes/parameters may be provided by a WTRU. In examples, the WTRU may provide attributes/parameters including information on the number of antenna elements/panels, number of radio frequency (RF) front end chains (e.g., per Uu link and/or SL), antenna configuration information, bandwidth support (e.g., per RF chain), and processing capabilities for transmission/reception of RF transmissions (e.g., PRS, SRSp, CSI-RS, SL transmissions, SL-PRS) for positioning. In examples, the WTRU may provide attributes/parameters including the synchronization source (e.g., gNB, relay WTRU, GNSS) and timing information (e.g., SFN, SFN start offsets, Direct Frame Number (DFN), DFN start offsets, TA over Uu link, TA over SL) supported/applied by the WTRU for data communications and/or positioning. The WTRU may indicate attributes/parameters including the priority value and/or preferred value associated with any of device parameters/attributes (e.g., preference for using Uu link or SL for communications and/or positioning) and timing information (e.g., priority of sync source, preference to use SFN or DFN).

Accuracy achievable may include the following. The WTRU may provide the one or more levels of positioning accuracy that may be achievable when performing positioning using different positioning techniques (e.g., DL-based, UL-based, SL-based). The WTRU may provide positioning accuracy information when using hybrid positioning (e.g., Uu-link and SL based) with assistance from one or more relay WTRUS, for example. The WTRU may indicate information on the timing error group (TEG) including WTRU Tx TEG IDs, WTRU Rx TEG IDs, WTRU Rx-Tx TEG IDs, for example. The WTRU may send the association information between SRSp resources and WTRU Tx TEG IDs, for example. The WTRU (e.g., the target WTRU or the relay WTRU) may indicate whether it is possible to simultaneously perform measurements and/or transmissions over Uu-link and SL for meeting a target accuracy value, for example. In examples, the WTRU may indicate a confidence/weight/probability (e.g., between 0 to 1) associated with Uu-link and/or SL based positioning. The confidence/weight/probability values may be associated with different granularities including positioning, PRS/SRSp/SL-PRS configurations, frequency layers, resource sets/resources, beams, etc. The WTRU may indicate the priority value and/or preference value associated with the accuracy level.

Transmission measurements/estimations may include the following. In examples, the WTRU may provide information on any of initial measurements (e.g., RSRP, time of arrival (ToA), timestamp, RSTD measurements) made on one or more transmissions including SSBs, CSI-RS, PRS, GNSS, SL-PRS, etc. In examples, the WTRU (e.g., target WTRU or relay WTRU) may provide information on the timing advance/alignment (TA) value associated with a Uu-link (e.g., with respect to a serving cell) and/or TA value associated with an SL (e.g., with respect to a relay/anchor WTRU). Such measurement/estimation of the TA may be done by the WTRU based on indication received from NW/relay WTRU (e.g., in a TA command) or estimated by the WTRU based on measurements, for example.

Reference locations, reference time instances, and trajectory may include the following. In examples, the WTRU may provide information (e.g., identifiers) on availability/accessibility to one or more reference locations associated with positioning reference units (e.g., WTRUs, TRPs, gNBs, cells, relay WTRUs, IAB nodes, NTN nodes, GNSS satellites) or detectable landmarks in proximity with the WTRU. The WTRU may provide the distances/ranges to the identified reference locations, for example. In examples, the WTRU may indicate information (e.g., IDs) on one or more positioning areas and/or zones associated with the coverage area of one or more cells/TRPs/gNBs/relay WTRUs, in which the WTRU may have been previously located, currently located, and/or expected to be located at different time instances.

Information on power saving modes may include the following. The WTRU (e.g., the target WTRU or the relay WTRU) may provide the power saving modes that may be supported and/or may be configured by the network including the timing information (e.g., timestamp) for when the WTRU may have been previously transitioned into or expected to transition into RRC CONNECTED, RRC INACTIVE, RRC IDLE or any other combination of power savings modes. The information on power saving modes provided by the WTRU may include one or more configuration information or parameters associated with CDRX/I-DRX/Discontinuous Reception (DRX) (e.g., cycle time on-duration, inactivity timer duration). The WTRU may indicate the priority value and/or preferred value associated with power saving modes/states supported along with location/area information and/or timing information on where/when such priority/preferred values may apply.

The information/indication listed regarding position may be sent by the target WTRU and/or the relay WTRU to the network or another peer WTRU (e.g., the relay WTRU or the target WTRU) when detecting a triggering event/condition or when receiving a request message. A target WTRU may send assistance information to a relay WTRU and may include (e.g., any of) the above information. The relay WTRU may send (e.g., any of) the above information to the target WTRU or the network, for example. The information/indication sent by the WTRU may be applicable to positioning described herein.

a PC5 may be set up between the target WTRU and relay WTRU, and the target WTRU may receive information about the positioning capabilities of the relay WTRU by sending an explicit request to the relay WTRU (e.g., PC5-RRC, MAC CE, etc.). The relay WTRU may send/push the information to the remote WTRU (e.g., without the need to receive a request from the WTRU).

The relay WTRU's positioning capabilities may be communicated to the target WTRU if a PC5 connection is not set up between the two. The positioning capabilities of the relay WTRU may be included in a relay discovery announcement transmitting from the relay WTRU. The target WTRU may include a request for the relay WTRU's positioning capability in the relay discovery solicitation message. The relay discovery solicitation message may be a solicitation message to let relay WTRUs include their positioning capabilities in the relay discovery response message. The target WTRU may specify one or more positioning capabilities in the solicitation message, and the relay WTRUs that fulfill the indicated capabilities may respond with the relay discovery response message.

The WTRU may be configured to perform relay (re)-selection that considers relay WTRU's positioning capabilities. In examples, the positioning capabilities of a relay WTRU may be used to determine the relay section or re-selection mechanisms by the target WTRU.

In examples, the target WTRU may be configured to prioritize the relay WTRUs that may have certain positioning capability or capabilities. In examples, the target WTRU (e.g., upon determining that a relay WTRU may supports certain positioning capabilities) may apply a positive offset to the Sidelink Reference Signal Receive Power (SL-RSRP) measurements towards the (e.g., concerned) relay WTRU (e.g., a relay WTRU that the WTRU is currently connected to, a neighboring relay WTRU, etc.)

In examples, the target WTRU may be configured to down-prioritize the relay WTRUs that may not have one or more positioning capabilities. In examples, the target WTRU, upon determining that a relay WTRU may not support certain positioning capabilities, may apply a negative offset to the SL-RSRP measurements towards the concerned relay WTRU (e.g., a relay WTRU that the WTRU may not be currently connected to, a neighboring relay WTRU, etc.)

The WTRU may be configured to monitor for triggering events/condition for sending info/indication associated with positioning. In examples, the triggering events/conditions monitored by the WTRU (e.g., target WTRU and/or relay WTRU) for sending indication and/or information including capability information, assistance information or requests for initiating, triggering, suspending, resuming, terminating any of the positioning techniques, or relay WTRU assisted positioning, may include one or more of the following. The WTRU may send the information/indications to the network or another peer WTRU (e.g., relay WTRU or target WTRU) when detecting the following triggering events/conditions: reception of an indication or request from higher layers/network; detection reference locations/times; positioning or ranging information (e.g., distance/direction); positioning information of the WTRUs; event triggered/periodic; or measurements of radio link conditions (e.g., Uu link and/or SL).

Reception of an indication or request from higher layers or network may include the following. In examples, the WTRU may send the info/indication when triggered by the LCS client/application in the WTRU (e.g., MO-LR) or by network (e.g., MT-LR, deferred MT-LR, NI-LR). The LCS client may provide a reference time (e.g., scheduled location time), and/or reference locations (e.g., PRUs, anchor WTRUs, relay WTRUs) for positioning, for example. The WTRU may obtain the indication/request from LCS client in one or more of the: the LCS message, LPP message, AS layer transmitting/channels (e.g., RRC, MAC CE, DCI, data). In examples, the WTRU may send information/indications upon receiving an LPP request message from network. The request message may include one or more of an explicit request for capability information, implicit request for information on measurements, detection of relay WTRUs in proximity, WTRU power saving modes, reference location/time, accuracy attributes, etc. In examples, a target/remote WTRU may send capability/assistance data when receiving an indication/request from a relay/anchor WTRU, or vice-versa, in (e.g., any of) higher layer transmitting (e.g., SLPP, RSPP) and AS layer transmitting (e.g., PC5-RRC, MAC CE, SCI). In examples, a target WTRU may send an indication to a relay WTRU via SL transmitting to send the capability/assistance information associated with the relay WTRU to the network.

Detection reference locations/times may include the following. In examples, the WTRU may send the information/indication to the network or another peer WTRU when detecting one or more reference locations (e.g., PRUs, positioning areas, TRPs, anchor WTRUs, relay WTRUs) and/or at reference time instances (e.g., scheduled location time).

Positioning or ranging information (e.g., distance/direction) may include the following. In examples, the WTRU (e.g., the relay WTRU or target WTRU) may send information/indications when determining that the distance from another peer WTRU (e.g., target WTRU or relay WTRU) may be above or below one or more distance threshold values. The distance to the peer WTRU may be determined from the RSRP or RTT measurements of the SL transmissions (SL-PRS, discovery, Physical SL Control Channel (PSSCH)) or estimated based on the TA values used for SL transmissions. The peer WTRU may be estimated to be within a certain distance if the RSRP of SL-PRS is within an RSRP threshold range, for example. In examples, the WTRU (e.g., the relay WTRU or target WTRU) may send information/indications when determining that the peer WTRU may be located in a particular direction from the WTRU within one or more direction/orientation angle threshold values. The direction of the peer WTRU may be determined based on the Rx beam direction used by the WTRU for receiving the SL transmissions (e.g., SL-PRS, PSSCH) transmitted by peer WTRU, measurements of power/phase of the SL transmissions sent by the peer WTRU when using a multi-antenna array at the WTRU, or an indication of a direction transmitted by the peer WTRU, for example. The direction of the peer WTRU may be estimated to be within a certain angle range/width (e.g., +10 degrees, −10 degrees) with respect to a reference direction (e.g., geographic north, direction of WTRU), and the RSRP of the SL transmission received using an Rx beam may be within an RSRP threshold range, for example.

Positioning information of the WTRUs may include the following. In examples, the WTRU (e.g., relay WTRU or target WTRU) may send information/indications to a peer WTRU (e.g., target WTRU or relay WTRU) that may be located within or in proximity to a preconfigured positioning area or a zone. The proximity to a zone (ID) may be determined based on whether the WTRU may be within a distance threshold to the intended zone or based on a number of zones separating the zone where the peer WTRU may be located and the intended zone, for example. The positioning areas/zone (e.g., any of the positioning areas/zones) may be associated with one or more positioning techniques and/or positioning configurations (e.g., PRS, SRSp, SL-PRS configurations).

In examples, a WTRU may send information and/or an indication periodically, for example, based on one or more periodicity values configured by network or another peer WTRU. In examples, the WTRU may send updated/new capability/assistance information when detecting any change in capability/assistance information with respect to a previous occasion when the information may be sent.

A WTRU may send measurements of radio link conditions (e.g., Uu link and/or SL conditions.) In examples, the WTRU may send the info/indication when measuring and/or detecting a change in the radio link/conditions. In examples, a WTRU may be configured to perform measurements on DL-PRS/CSI-RS/SSB received from one or more TRPs/cells (e.g., serving cell and/or neighbour cells) or estimate TA values. In examples, the WTRU may be configured to measure SL-PRS/SL-RS/SL-SSB received from one or more relay/anchor WTRUs. The WTRU may send the information/indication when the measurement values (e.g., RSRP, Received Signal Strength Indicator (RSSI), CBR, TA) may be within one or more threshold values or increase/decrease by certain corresponding threshold values.

The triggering events/conditions (e.g., any of the triggering events/conditions) described herein may be configured and/or monitored by one or more of the target WTRU or relay WTRU for sending an (e.g., any) indication/information to one or more of a network (e.g., gNB, LMF) or another peer WTRU. In examples, the relay WTRU may send assistance information/indications to a target WTRU or network based on one or more of the triggering events described herein. A target WTRU may send assistance information/indications to the relay WTRU or network based on one or more of the triggering events described herein.

The triggering events/conditions listed may be applicable to the techniques described herein. The indication/information sent by the WTRU when detecting the triggering events/conditions may include one or more of (e.g., any of) the following: capability information; a request for assistance information; a request for new/updated SRSp/PRS/SL-PRS configurations; a request for activating/deactivating a preconfigured SRSp/PRS/SL-PRS configurations; an indication to a start of SRSp/SL-PRS transmission or a start of PRS/SL-PRS measurement; a request for one or more relay WTRUs (e.g., alternative/new relay WTRUs); or an indication of detection of a triggering event.

A WTRU may send the indications in RRC CONNECTED state, RRC INACTIVE state, or RRC IDLE state. In examples, when the WTRU is in INACTIVE state, the WTRU may send the indication (e.g., using the RRCResumeRequest message or a MAC CE) using SDT-Random Access Channel (RACH) or SDT-Configured Grant (CG) resources. In examples, when the WTRU is in IDLE state, the WTRU may send the indication in one or more of an initial access/RACH message (e.g., RRCRequest, RRCSystemInformation request, RRCReconfiguration request, or a RACH/RRC message associated with positioning). In examples, the WTRU may send the indication when in IDLE state using a RACH occasion associated with positioning. When sending the indication in an INACTIVE/IDLE state, the WTRU may include a flag/cause info, such that the WTRU may not be transitioned to a CONNECTED state. In examples, the WTRU may send the indication to the network upon transitioning to a CONNECTED state for non-positioning or positioning related causes.

The WTRU may receive assistance data/configuration information for supporting relay WTRU assisted positioning. In examples, the WTRU (e.g., target WTRU and/or relay WTRU) may receive assistance data and/or configuration information for supporting any of the positioning techniques (e.g., DL-based, UL-based, SL-based, Hybrid Uu+SL based). The assistance data and/or configuration information may be received by the WTRU from the LMF, gNB and/or a peer WTRU (e.g., relay WTRU), for example. The assistance data may be received by the WTRU in one or more of the following: positioning SIB (posSIB) (e.g., for example, the WTRU may receive the posSIB from the network (e.g., when in coverage) or from the relay WTRU (e.g., when in OOC)); higher layer transmitting (e.g., LPP, SLPP, RSPP, discovery messages); Uu-link AS layer transmitting/channels (e.g., RRC, MAC CE, DCI, Physical Downlink Shared Channel (PDSCH); or SL AS layer transmitting (e.g., PC5-RRC, MAC CE, SCI, PSSCH).

The WTRU may receive the assistance data/configuration information associated with relay WTRU assisted positioning due to one or more of (e.g., any of) the following triggers: upon sending a request, periodically, or a detection of configured events/conditions.

The WTRU may receive the assistance data/configuration information associated with the relay WTRU assisted positioning upon sending a request. In examples, the WTRU may send a request for assistance data to the network (e.g., LPP message on-demand SI, AS layer transmitting) indicating information/identifiers/configuration/parameters associated with one or more of (e.g., any of) a positioning session (e.g., LPP/SLPP session), a positioning technique (e.g., Uu-link based, SL-based), access nodes (e.g., TRPs, gNBs, cells) or relay WTRUs. The WTRU may receive the corresponding assistance data. In examples, a target WTRU connected to the network via a relay WTRU may send the request for assistance data (e.g., LPP request) by including the IDs of the relay WTRU and/or serving cell of the target WTRU/relay WTRU. In examples, the WTRU may receive the assistance data (e.g., in LPP message) after sending capability information and/or any other indications/messages (e.g., on-demand request, LCS messages, LPP messages, positioning info/report).

The WTRU may receive the assistance data/configuration information associated with the relay WTRU assisted positioning periodically. In examples, the WTRU may be configured by the network to receive assistance data periodically from the network or relay WTRU with a certain configured periodicity. In examples, the WTRU may request to change the periodicity for receiving assistance data based on a detection of one or more events including a change of link conditions (e.g., Uu-link or SL measurements increase/decrease by some threshold values), change in a power saving state of target/relay WTRU (e.g., when transitioning from CONNECTED to INACTIVE), change of a mobility state of target WTRU and/or relay WTRU (e.g., from stop state to mobile state), or change in accuracy/uncertainty of relay WTRU location info, etc.

The WTRU may receive the assistance data/configuration information associated with the relay WTRU assisted positioning due to a detection of configured events/conditions. In examples, the WTRU may receive one or more assistance data associated with positioning techniques (e.g., PRS, SRSp, SL-PRS configurations), access nodes (e.g., TRPs), or relay/anchor WTRUs. The WTRU may store the assistance data and retrieve for future positioning procedures/sessions (e.g., LPP sessions), for example. The WTRU may receive validity conditions (e.g., positioning area validity, time validity) and/or events associated with suspending/resuming/releasing the assistance data. In examples, the WTRU may use the preconfigured assistance data so long as the validity conditions may be met and/or no events invalidating the preconfigured assistance data are detected by the WTRU. In examples, the WTRU may receive updated/new assistance data when the validity conditions expire and/or events invalidating the preconfigured assistance data may be detected by WTRU. In examples, the updated/new assistance data may be received based on an indication sent by the WTRU to the network or another WTRU indicating the expiry of validity conditions, detection of events, and/or a request for new/updated assistance data.

The assistance data/configurations received by the WTRU (e.g., the target WTRU and/or relay WTRU) from the network or another peer WTRU may include one or more of the following: identifiers/indexes/flags, positioning configurations, timing information for positioning, location information, positioning measurement/transmission time instances and/or time windows, priority values, error and QoS thresholds, correction/compensation information, or a reporting configuration.

In examples, the assistance data/configurations received by the WTRU may include identifiers/indexes/flags.

In examples, the target WTRU may receive IDs/indexes of one or more access nodes (e.g., TRPs, cells) and/or relay WTRU/anchor WTRUs that may be used for positioning. In examples, fixed/stationary relay WTRUs and mobile relay WTRUs may be indicated with different flags/indexes.

In examples, the relay WTRU may receive assistance data from the network associated with one or more target WTRUs (IDs) that may be connected to the relay WTRU. Such assistance data may be received by the relay WTRU based on indications/request messages sent by the relay WTRU to the NW, including the IDs of the target WTRUs, for example. In an example a relay WTRU may be subjected to different mobility states at different time instances/durations, including moving with a fixed speed, stopping, resuming movement, increasing/decreasing speed, etc. The target WTRU may receive information on mobility state/status of the relay WTRU, for example, along with the time instance/duration when the mobility state changes or expected to change.

In examples, the assistance data/configurations received by the WTRU may include positioning configurations. In examples, the WTRU may receive one or more PRS, SRSp, and SL-PRS configurations/resources (e.g., IDs) which may be associated with/intended for positioning using one or more relay/anchor WTRUs. In examples, the positioning configurations (e.g., PRS, SRSp, SL-PRS) may be associated with one or more frequency layers, resources, resource sets, beams, TRPs, and/or relay/anchor WTRUs. In examples, the one or more positioning configurations associated with a relay WTRU may be used by a target WTRU when connected to the relay WTRU via SL.

The types of positioning configurations (e.g., PRS, SRSp, SL-PRS) received by the WTRU may include one or more of aperiodic, semi-persistent, and periodic. In examples, the WTRU may receive the reference node to use when supporting TDOA based positioning. The WTRU may receive the reference cell/TRP (ID) to use when supporting DL-TDOA or the reference anchor WTRU (ID) to use when supporting SL-TDOA. The indication of the reference node may allow the WTRU to perform RSTD measurements (e.g., a difference between the time-of-arrival of PRS/SL-PRS received from the reference node and another node). In examples, the WTRU may be configured for multi-round trip time (RTT) positioning with one or more TRPs, and the WTRU may receive both the PRS configurations and SRSp configurations from the network and/or from the relay WTRU.

In examples, the WTRU may receive information on one or more measurement gap configurations (e.g., IDs) from the network and/or relay WTRU, which may be associated with the PRS configurations to be used during measurements. Such measurement gap configurations may be aligned with the timing information (e.g., SFN, start offsets) provided by a network or relay WTRU to the target WTRU, for example. In examples, the WTRU (e.g., relay WTRU) may assist the peer WTRU (e.g., target WTRU) for performing UL-based positioning (e.g., by determining and/or providing the SRSp parameters (e.g., bandwidth, density, periodicity, Tx power)) to use during transmission based on certain conditions including measurements of SSB/PRS reported by the target WTRU, relative location of the peer WTRU (e.g., distance between relay WTRU and target WTRU, positioning area/zone where the target WTRU may be located), etc.

In examples, the assistance data/configurations received by the WTRU may include timing information for positioning. In examples, the target WTRU may receive from the network or relay WTRU the timing information associated with the positioning configurations such as a frame number (e.g., SFN), start offset slot, periodicity and stop offset slot. In examples, when connected to a relay WTRU, the relay WTRU may provide to the target WTRU the SFN information of the serving cell or timing adjustments/offsets (e.g., so that the target WTRU may derive the SFN of the serving cell from the DFN for performing Uu-link based positioning). The timing information that may be used by a target WTRU for positioning may be associated with the relay WTRU and/or the serving cell of the relay WTRU, for example. In examples, where the WTRU may be configured with positioning configurations (e.g., PRS, SRSp), the WTRU may apply certain timing offsets to the positioning configurations based on the timing information provided by the relay WTRU and/or serving cell, for example.

In examples, the assistance data/configurations received by the WTRU may include location information. In examples, the target WTRU may receive the location information of one or more relay WTRUs and/or access nodes (e.g., TRPs) that may be used for any of the positioning modes (e.g., WTRU-based positioning). The location information may be in the form of absolute positioning information (e.g., global coordinates) or relative positioning information (e.g., local coordinates, distance/direction to a reference point). In examples, the location information of the relay WTRU may be received directly from the relay WTRU over SL (e.g., in SLPP/RSPP transmitting). In examples, the WTRU may receive the uncertainty information associated with the location of the access nodes or relay WTRUs used (e.g., for positioning the target WTRU).

In examples, the assistance data/configurations received by the WTRU may include positioning measurement/transmission time instances and/or time windows. In examples, the target WTRU may receive from a relay WTRU or network the information of one or more measurement/transmission time instances (e.g., t0, t1, t2, . . . , ti), indicating the time slots/occasions when the WTRU may perform PRS measurements and/or SRSp transmissions. The time instances may be associated with a start offset time slot (e.g., ti−T1, corresponding to the earliest time slot for starting positioning measurements/transmissions), duration (e.g., number of time slots), and a stop offset time slot (e.g., ti+T2, corresponding to the latest time slot for stopping positioning measurements/transmissions), for example. The separation duration between different time instances may be configured to be fixed or variable. When the duration between time instances is fixed, the WTRU may perform positioning measurements/transmissions periodically with a fixed periodicity, for example.

In examples, the WTRU may receive one or more time windows, indicating a positioning duration when the WTRU may perform PRS measurements and/or SRSp transmissions from/to one or more access nodes/TRPs and/or relay WTRUs. In examples, the duration of a time window may correspond to the maximum latency for determining the WTRU location based on PRS measurements and/or SRSp transmissions. The measurement time instances and/or time windows may be identified by IDs/indexes and/or may be associated with the one or more access nodes/TRPs or relay WTRUs used by the WTRU for positioning, for example.

In examples, where the target WTRU may be configured for multi-round trip time (RTT) positioning with one or more access nodes, the WTRU may receive the RTT configuration (e.g., from the relay WTRU) consisting of a set of time instances (e.g., for performing PRS measurements and a set of time instances for performing SRSp transmissions).

In examples, the assistance data/configurations received by the WTRU may include priority values. In examples, the WTRU may receive or be configured with priority values associated with one or more positioning techniques (e.g., DL-based, UL-based, SL-based) to be used when connected to the network via a relay WTRU. Such priority values may indicate the preference for using a positioning technique when the WTRU is connected to a relay WTRU, for example.

The WTRU may receive from the relay WTRU or network the priority values associated with one or more access nodes (e.g., TRPs) and/or relay/anchor WTRUs to use for positioning. Such priority values may indicate the preference for selecting/using one or more access nodes and/or relay WTRUs for positioning, for example.

In examples, the WTRU may receive priority values from the relay WTRU or network, indicating the PRS/SRSp configurations to use when performing positioning with a set of one or more access nodes/TRPs. In examples, the WTRU may select a TRP and/or an associated PRS/SRSp configuration based on the order of priority. The TRP and/or the associated PRS/SRSp configuration with the highest priority may be used first for positioning measurements followed by the next highest priority.

In examples, the assistance data/configurations received by the WTRU may include error and QoS thresholds. In examples, the WTRU may receive one or more error thresholds associated with measurements (e.g., RSRP, RSTD, TOA, RTOA, number of multipaths) and/or positioning QoS (e.g., accuracy, integrity, latency). In examples, the error threshold may be associated with a determination of dilution of precision (DOP). A DOP condition may be determined as follows: given the location of WTRU, the difference/diversity in the location of one or more access nodes or relay WTRUs/anchor WTRUs used for positioning may be less than a threshold, for example. In examples, the positioning error may be determined based on whether the calculated/detected DOP condition may be above/below a DOP error threshold, for example. The error threshold values may be used by the WTRU for determining whether the positioning measurements may be within the expected error bounds/thresholds and/or whether the positioning QoS requirements may be met, for example, when performing measurements of DL or SL transmissions (e.g., PRS, SSB, SL-PRS) received from access nodes or relay/anchor WTRUS.

In examples, the assistance data/configurations received by the WTRU may include correction/compensation information. In examples, the WTRU may receive correction/compensation info/parameters to apply when performing measurements of DL or SL transmissions (e.g., PRS, SL-PRS) received from TRPs and/or anchor WTRUs/relay WTRUs. In examples, the correction information may include one or more TA values (e.g., cell-specific TA value, reference TA value, and/or WTRU-specific/differential TA values). In examples, the cell-specific TA value and/or the reference TA value may be the TA value used by the relay WTRU when transmitting to the serving cell of the relay WTRU. The WTRU-specific TA value may be related to the TA value applied by the target WTRU when transmitting any transmissions to the relay WTRU over SL. The TA value used by the target WTRU with respect to the network and/or during SRSp transmission in UL may be determined based on the cell-specific and WTRU-specific TA values, for example.

In examples, the target WTRU may receive from the relay WTRU and/or network the TA values (e.g., cell-specific, WTRU-specific) to be used when transmitting SRSp to one or more TRPs/cells, including the serving cell of the relay WTRU. In examples, the target WTRU may determine the TA value to use when transmitting SRSp to any of the TRPs based on assistance data (e.g., cell-specific TA) provided by the relay WTRU and/or RSRP measurements or estimation of the distance of the WTRU with respect to the TRP and/or the relay WTRU. In examples, the target WTRU may be preconfigured by the network or relay WTRU with one or more TA values to select and use when transmitting SRSp to one or more TRPs. The target WTRU may select a TA value based on the RSRP measurements or estimation of the distance to the TRPs and/or relay WTRU, for example. The WTRU may receive correction/compensation information/parameters to apply when performing transmissions of SRSp to TRPs, measurements of PRS received from TRPs, or transmissions of SL-PRS to relay WTRUS.

In examples, the correction information may be related to timing/phase errors (e.g., associated with TRPs, PRS configuration), indicating the difference between the time instance/phase when the PRS may be generated and transmitted by the TRPs. The correction information may be related to timing/phase errors (e.g., associated with WTRU, and/or SRSp configuration), indicating the difference between the time instance/phase when the SRSp may be generated and transmitted by the WTRU, for example.

In examples, the correction information received by the WTRU may be related to timing/phase errors expected at different cells, positioning areas, coverage areas, or reference areas. The WTRU may use the corresponding correction information when performing measurements of PRS, and/or transmission of SRSp.

In examples, the WTRU may receive correction info/thresholds associated with error sources at the TRPs, relay WTRUs, and channels/links (e.g., Uu link, SL between relay WTRU and target WTRU), including synchronization errors, timing errors (e.g., Tx TEG IDs, Tx-Rx TEG IDs, Rx TEG IDs at TRPs and relay WTRUs), multipath, LOS/NLOS, and errors in location information of TRPs and/or relay WTRUS. Such correction information may be used by the target WTRU when operating in WTRU-based mode and where the target WTRU may estimate its location based on PRS and/or SL-PRS measurements), for example.

In examples, the assistance data/configurations received by the WTRU may include a reporting configuration. In examples, the WTRU may receive reporting configuration to apply when sending the positioning measurements when performing relay WTRU assisted positioning. In examples, the reporting configuration may include the IDs/indexes to be used (e.g., LPP/SLPP ID, TRP/cell ID, serving cell ID, relay WTRU ID, positioning technique ID). In examples, the reporting configuration may include whether to report absolute/averaged/min/max values related to measurements made on the PRS (e.g., ToA, RSRP, RSTD measurements made on resources/beams/TRP/cells associated with PRS).

In examples, the reporting configuration may include the reporting periodicities (e.g., whether reporting is to be aligned with measurements/transmissions), offsets with respect to start/end of measurements, and events that the WTRU may monitor/detect for sending reports to network via relay WTRU. In examples, the WTRU may send a report on positioning measurements/estimation/uncertainty when detecting a change in radio conditions (e.g., RSRP above/below a threshold) and detecting a change in a mobility state of the relay WTRU.

The WTRU may include timing information (e.g., timestamps) in the reports, indicating that the SFN may have been applied and time instances of when the measurements may have been started/stopped, for example. In examples, when the WTRU may perform prediction/extrapolation/interpolation during time instances when PRS or SL-PRS measurements may not be made or when SL to relay WTRU may not be available, the WTRU may send the timing information (e.g., timestamps) related to the associated start time, duration and/or stop time. When performing extrapolation/interpolation of measurements, the WTRU may send information on one or more of the uncertainty of the prediction, confidence value, or weight values associated with instances of the extrapolated/interpolated measurement values.

The assistance information/indications described herein may be received by target WTRU and/or relay WTRU from the network or another peer WTRU (e.g., relay WTRU or target WTRU) when transmitting a request message or when triggered by an event, for example.

The assistance data received by WTRU may be common across positioning areas (e.g., including multiple cells/TRP) or specific to one or more cells/TRPs. When a target WTRU receives from the relay WTRU or network one or more of the positioning area, TRP, or cell-specific assistance data, the WTRU may use the associated assistance data when under the coverage of the positioning area/TRP/cell, for example. Likewise, the relay WTRU may provide the positioning area/TRP/cell-specific assistance data to a target WTRU upon determining or receiving an indication that the target WTRU may be under the coverage of the associated positioning area/TRP/cell, for example.

Techniques at the Target WTRU may support relay WTRU assisted positioning. The WTRU may be configured for WTRU-based and/or WTRU-assisted positioning with assistance from the relay WTRU. In examples, the WTRU (e.g., target WTRU) may be configured for positioning (e.g., with the assistance and support from one or more relay WTRUs) when using one or more of a WTRU-based positioning mode and a WTRU-assisted (network-based) positioning mode.

In a WTRU-based positioning mode, the WTRU may perform measurements of a PRS received from the access nodes (e.g., TRPs). The WTRU may calculate the location of the WTRU based on the measurements and the location information of the access nodes. In examples, the relay WTRU may support PRS transmission, and the WTRU may perform measurements of PRS received from the relay WTRU. The WTRU may calculate the location of the WTRU based on the measurements and location information of the relay WTRU.

In examples, the WTRU may receive a PRS from one or more access nodes and receive SL-PRS from one or more anchor WTRUs (e.g., including the relay WTRU), and the WTRU may perform measurements of PRS and SL-PRS at different time instances. The WTRU may calculate the location of the WTRU based on the PRS and SL-PRS measurements and location information of the access nodes and anchor/relay WTRUs.

The assistance data, including one or more of the PRS configurations, SL-PRS configurations, location information of access nodes and anchor/relay WTRUs, or correction info, may be configured/received directly from the relay WTRU or indirectly from the network via the relay WTRU, for example. When calculating the WTRU location, corrections may be applied by the WTRU by accounting for any errors due to the relative location of the WTRU with respect to the relay WTRU or access nodes, for example.

In a WTRU-assisted (network-based) positioning mode, the WTRU may perform measurements of PRS received from the access nodes and/or SL-PRS received from anchor WTRUs/relay WTRUs and send the measurement report to network (e.g., LMF, gNB) for calculating the WTRU location. The assistance data, including one or more of the PRS configurations and SL-PRS configurations, may be configured/received directly from the relay WTRU or indirectly from the network via the relay WTRU, for example. The measurement report transmitted to the network via the relay WTRU, may include one or more of (e.g., any of) PRS measurements, SL-PRS measurements, information of the access nodes and WTRUs (e.g., TRP IDs, anchor/relay WTRU IDs) used for positioning, and timing information (e.g., time stamps) for indicating the time instances when the PRS and SL-PRS measurements may be made. The timing information (e.g., included by the WTRU in the measurement report) may be indicated as a relative time with respect to a starting/reference time (e.g., SFN, DFN), and may be provided to the target WTRU by the relay WTRU.

In examples, the WTRU may be configured to use one or more PRS configurations and/or PRS parameters (e.g., periodicity, bandwidth) based on the relative location or distance/direction of the target WTRU with respect to the relay WTRU and/or access nodes (e.g., TRPs). In examples, the WTRU may use a first PRS configuration when the distance to the relay WTRU may be within a first distance threshold range and use a second PRS configuration when the distance to the relay WTRU may be within a second distance threshold range. Such PRS configurations/parameters may be applicable for WTRU-based and WTRU-assisted modes and may be used for ensuring high accuracy and reliable PRS measurements when using access nodes outside of the coverage of a serving cell.

In examples, the WTRU may select/determine to use a first PRS configuration (e.g., first set of PRS resources) with one or more of high resource density, high periodicity, high repetitions, and/or high bandwidth parameters if the number of TRPs available with high RSRP (e.g., RSRP of PRS/SSB above an RSRP threshold) is above a threshold. The WTRU may select/determine to use a second PRS configuration (e.g., second set of PRS resources) with one or more of a relatively low density, low periodicity, and/or low bandwidth parameters if the number of TRPs available with high RSRP (e.g., RSRP of PRS/SSB above an RSRP threshold) is below a threshold or if the RSRP of PRS/SSB received from the TRPs is below an RSRP threshold value, for example. In examples, the WTRU may determine whether to use the first or second PRS configuration for performing measurements of PRS received from TRPs based on one or more of a determination of distance/direction to the relay WTRU or based on RSRP measurements of SL-PRS/SL transmissions received from the relay WTRU, for example.

In examples, for enabling the WTRU to select/determine a suitable PRS or SL-PRS configuration/parameters, the WTRU may be preconfigured with one or more PRS/SL-PRS configuration/parameters, one or more threshold values associated with the relative location, distance/direction, and measurements (e.g., RSRP of Uu link transmissions, RSRP of SL transmissions). Such configuration information may be received by the WTRU from the network (e.g., the LMF, gNB) or from the relay WTRU as assistance data, for example.

The WTRU may select one or more PRS/SL-PRS configurations/parameters to use for performing measurements of a PRS received from the access nodes or measurements of SL-PRS received from anchor/relay WTRUs based on the assistance data, for example. In examples, the WTRU may send an indication (e.g., an on-demand indication via relay WTRU) to the network (e.g., LMF, gNB) or relay WTRU to request for updating, activating, or deactivating the selected PRS configuration/parameter, for example. In examples, the WTRU may send to the relay WTRU and/or network the measurements of the transmissions (e.g., PRS, SSB, SL-PRS) received from the access nodes or other WTRUs. The WTRU may (e.g., then) receive from the network or relay WTRU the PRS/SL-PRS configurations/parameters and/or activation/deactivation indication triggering the use of the PRS/SL-PRS configurations/parameters, for example.

The WTRU may determine the positioning technique to apply when in OOC or partial coverage scenarios. In examples, the WTRU (e.g., the target WTRU) may determine/select one or more positioning techniques (e.g., Uu-link based, SL-based, hybrid Uu+SL based) based on a criteria described herein. The criteria, including one or more parameters/threshold values associated with the positioning techniques may be configured by the network (e.g., via RRC or LPP transmitting) or the relay WTRU. In examples, the Uu-link based positioning techniques that may be selected (e.g., by the WTRU) for positioning with the assistance from relay WTRU may include one or more (e.g., any) of DL-TDOA, DL-AOD, UL-TDOA, UL-AOA, or multi-RTT. Similarly, the SL-based positioning techniques that may be selected may include one or more of SL-TDOA, SL-AOA, SL-AOA, or SL-RTT, for example. If a WTRU is in OOC or in partial coverage scenarios (e.g., the target WTRU may be in OOC and relay WTRU may be in coverage), the WTRU may be triggered to select a positioning technique for determining the WTRU location upon receiving a location request from higher layer (e.g., MO-LR, MT-LR, NI-LR).

The WTRU may select/determine the positioning based on one or more (e.g., any) of the following: measurements associated with Uu-link and/or SL coverage; indication from a network or relay WTRU; positioning QoS; availability of relay WTRUs; availability/reliability of resources for SL-based positioning; or priority.

The WTRU may select/determine the positioning based on measurements associated with Uu-link and/or SL coverage. In examples, the WTRU may determine to use Uu-link based positioning (e.g., DL-based, UL-based, multi-RTT), and (e.g., if) the RSRP measurements of the SSB/PRS/CSI-RS received from TRPs is above/below one or more RSRP threshold values and/or remains above/below the RSRP threshold values for a duration (e.g., a time duration), the WTRU may determine to use Uu-link positioning if the number of TRPs with an RSRP above a threshold value and/or with LOS conditions are above a TRP count threshold value, for example.

In examples, the WTRU may be connected to a serving cell via a relay WTRU. The RSRP of the SSB/PRS/CSI-RS received from the serving cell may be above/below (e.g., some) RSRP threshold values, and the WTRU may include the serving cell, along with other TRPs/cells, in the measurements when determining to use Uu-link based positioning. The WTRU may include the TRPs/cells outside the coverage of the serving cell and not the serving cell for Uu-link based positioning if the RSRP of the SSB/PRS/CSI-RS received from the serving cell may be below (e.g., some) RSRP threshold values, for example.

In examples, the WTRU may determine to use SL-based positioning (e.g., SL-TDOA) if the RSRP measurements of SL transmissions (e.g., SL-PRS, discovery messages, PSSCH) received from one or more anchor WTRUs (e.g., including/excluding relay WTRU) is above/below one or more RSRP threshold values (e.g., the RSRP of the SL PRS may be above an RSRP threshold). The WTRU may determine to use SL-based positioning if the RSRP of the SSB/PRS/CSI-RS received from TRPs/gNBs is below some RSRP threshold values, for example. The WTRU may determine to use SL-based positioning if the number of anchor WTRUs with RSRP above a threshold value and/or with LOS conditions are above an anchor WTRU count threshold value, for example.

In examples, the WTRU may determine to use hybrid Uu+SL based positioning if one or more of the following are true: an RSRP of the SSB/PRS/CSI-RS received from one or more TRPs is above/below some RSRP threshold values; an RSRP of the SL transmissions (e.g., SL-PRS) received from one or more anchor WTRUs is above/below some RSRP threshold values; or the total number consisting of the number of TRPs with an RSRP above a threshold value and the number of anchor WTRUs with an RSRP above a threshold value are above a node count threshold value.

The WTRU may select/determine the positioning technique based on an indication from the network or relay WTRU. In examples, the WTRU may use Uu-link based, SL-based or hybrid Uu+SL based positioning based on an indication of the positioning received from the network (e.g., in LPP, RRC, MAC CE, DCI) or from the relay WTRU (e.g., in SLPP/RSPP, PC5-RRC, MAC CE, SCI). The WTRU may select/determine the positioning based on a positioning QoS.

In examples, the WTRU may determine/select Uu-link based positioning when the positioning accuracy may be (e.g., relatively) high (e.g., <1 m horizontal/vertical accuracy) and one or more TRPs that may support Uu-link based positioning with the desired accuracy may be available.

When determining Uu-link based positioning, the WTRU may select UL-TDOA when the WTRU may be located with low latency. UL-based positioning may be used for avoiding delays associated with DL-based positioning due to measurements at a WTRU and sending measurement reports via multiple hops (e.g., via a relay WTRU).

In examples, the WTRU may determine/select SL-link based positioning if the positioning latency requirement is low (e.g., below a threshold value) and one or more anchor WTRUs (e.g., that may support SL-link based positioning with the desired accuracy) may be available.

In examples, the WTRU may determine/select hybrid Uu+SL-link based positioning when the positioning accuracy may be (e.g., relatively) high and/or positioning latency may not be stringent (e.g., less stringent) and the number of TRPs and anchor WTRUs available in combination for positioning may be above a threshold.

The WTRU may select/determine the positioning technique based on an availability of relay WTRUs. In examples, the WTRU may determine to use Uu-based positioning when the WTRU establishes connection with at least one relay WTRU for receiving positioning assistance data/resources from the network. If no relay WTRUs that may assist/support positioning may be available/detectable, the WTRU may select to use SL-based positioning.

The WTRU may select/determine the positioning technique based on an availability/reliability of resources for SL-based positioning. In examples, the WTRU may determine/select to use SL-based positioning upon identifying that the availability of resources for SL positioning based on measurements over SL (e.g., RSRP, RSSI, CBR measurements when operating in Mode 2) or indication from one or more anchor WTRUs) are above/below a threshold (e.g., CBR threshold) and/or remain above/below the threshold for a duration. If the resources for SL-based positioning are not available and TRPs for supporting Uu-link based positioning are available, the WTRU may determine to use Uu-based positioning, for example.

The WTRU may select/determine the positioning technique based on a priority value. In examples, in the case when both Uu-link based and SL-based positioning may be used, the WTRU may determine to use Uu-based positioning with higher priority than SL-based positioning when the WTRU has established connectivity over SL with at least one relay WTRU that may be able to assist/support positioning.

The WTRU may select (e.g., reselect) a relay WTRU for supporting or assisting with positioning. In examples, the WTRU (e.g., target WTRU) may select (e.g., reselect) one or more relay WTRUs to assist and/or support the target WTRU with positioning based on a set of one or more events/conditions/criteria. The selection criteria may be preconfigured in the WTRU, received from the network (e.g., as assistance data) and/or received from a peer WTRU (e.g., non-positioning relay WTRU, anchor WTRU) over SL, for example.

The WTRU may perform selection of a relay WTRU for positioning when triggered by a location request (e.g., MO-LR) and/or when determining the positioning to apply, for example. Upon identifying a potential relay WTRU for positioning and/or selecting the relay WTRU, the target WTRU may send a request message to the relay WTRU via SL (e.g., via PC5-RRC, MAC CE, SCI, PSSCH) or to network (e.g., via the relay WTRU). The relay WTRU may be used for positioning purposes, for example, when the relay WTRU receives a response message/indication from the relay WTRU or from the network.

A WTRU may trigger the relay WTRU selection (e.g., reselection) procedure and/or select (e.g., reselect)a relay WTRU based on one or more of the following events/conditions/criteria: measurements associated with SL and/or Uu-link; coverage of posSIB and/or PRS; distance/direction to relay WTRU; positioning information of the relay WTRU; association with the relay WTRU used for data communications; a serving cell of the relay WTRU; a capability of the relay WTRU for positioning; a positioning QoS; a priority; or a reception of an indication from network.

The WTRU may trigger the relay WTRU selection (e.g., reselection) and/or select (e.g., reselect) a relay WTRU based on measurements associated with an SL and/or Uu link. In examples, the WTRU may trigger the selection of a relay WTRU when the RSRP measurements of Uu-link of the serving cell may be above/below one or more RSRP threshold values (e.g., below a threshold value). The WTRU may trigger the relay WTRU selection when the RSRP measurements of Uu-link of neighbor cells may be above/below one or more RSRP threshold values (e.g., above a threshold value). The WTRU may select a relay WTRU from a set of available candidates if the RSRP measurements of SL transmissions (e.g., SL-PRS, discovery messages, PSSCH) received from the relay WTRU are above/below one or more RSRP threshold values, for example.

The WTRU may trigger the relay WTRU selection (e.g., reselection) procedure and/or select (e.g., reselect)a relay WTRU based on coverage of posSIB and/or the PRS. In examples, the WTRU may trigger the selection of a relay WTRU when determining the coverage of SIB (e.g., posSIB) received from a serving cell or when (e.g., any of) the neighbor cells may be lower than the coverage of PRS. The WTRU may trigger the relay WTRU selection when the RSRP of SSB/posSIB received from the neighbor/serving cell may be below a first RSRP threshold and the RSRP of PRS received from neighbor/serving cell may be above a second RSRP threshold, for example. The WTRU may trigger the relay WTRU selection when the RSRP of PRS received from the serving cell may be below an RSRP threshold value, for example. The selection and/or use of the relay WTRU may allow the WTRU to receive assistance data from the network (e.g., via LPP), for example.

The WTRU may trigger the relay WTRU selection (e.g., reselection) procedure and/or select (e.g., reselect) a relay WTRU based on a distance/direction to the relay WTRU. In examples, the WTRU may select a relay WTRU whose distance from the target WTRU may be above/below one or more distance threshold values. The distance to the relay WTRU may be determined from the RSRP or RTT measurements of the SL transmissions (SL-PRS, discovery, PSSCH), for example. The distance to the relay WTRU may be estimated from a TA value (e.g., a TA value used for SL transmissions (e.g., data transmissions)). In examples, the WTRU may select a relay WTRU that may be located in a particular direction from the target WTRU within one or more direction/orientation angle threshold values. The direction to the relay WTRU may be determined based on the Rx beam direction used at the target WTRU or SL transmissions power/phase received from the relay WTRU when using multi-antenna array at the target WTRU, for example.

The WTRU may trigger the relay WTRU selection (e.g., reselection) procedure and/or select (e.g., reselect) a relay WTRU based on positioning information of the relay WTRU. In examples, when supporting WTRU-based positioning, the WTRU may select a relay WTRU whose location information and attributes (e.g., accuracy, uncertainty, integrity) are provided to/made available for the target WTRU. When multiple candidate relay WTRUs are available, the WTRU may select a relay WTRU with the highest accuracy and/or lowest uncertainty, for example. In examples, the WTRU may select a relay WTRU that may be located within or in proximity to a positioning area or zone associated with the one or more TRPs where the WTRU may perform Uu-link based positioning (e.g., DL-based or UL-based).

The WTRU may trigger the relay WTRU selection (e.g., reselection) procedure and/or select (e.g., reselect) a relay WTRU based on an association with the relay WTRU used for data communications. In examples, the WTRU may be configured or select the same relay WTRU selected for data communications for positioning purposes (e.g., for requesting assistance data or posSIB). In examples, the WTRU may select and/or use different relay WTRUs for data communications and positioning, for example, if the selected relay WTRU is not overloaded for supporting multiple services and multiple target WTRUS.

The WTRU may trigger the relay WTRU selection (e.g., reselection) procedure and/or select (e.g., reselect) a relay WTRU based on a serving cell of the relay WTRU. In examples, the WTRU may select a relay WTRU based on whether the serving cell of the relay WTRU may assist or support the positioning of the target WTRU.

The WTRU may trigger the relay WTRU selection (e.g., reselection) procedure and/or select (e.g., reselect) a relay WTRU based on a capability of the relay WTRU for positioning. In examples, the WTRU may select a relay that may assist or support same/similar positioning techniques supported by the target WTRU. The WTRU may select a relay WTRU based on the availability of assistance data and/or configurations (e.g., posSIB, PRS configurations, SRSp configurations, SL-PRS config) at the relay WTRU associated with the positioning technique, access nodes (e.g., TRPs), or anchor WTRUs (e.g., used by the target WTRU for positioning). In examples, the WTRU may select a relay WTRU that may provide any of posSIB, assistance data including PRS configurations, and timing information associated with a serving cell (e.g., SFN info) when determining to use DL-based positioning technique. When the WTRU determines to use SL-based positioning, the WTRU may select a relay WTRU that may perform transmissions or measurements of SL-PRS, for example. The WTRU may select a relay WTRU based on whether the relay WTRU may have a capability to perform PRS transmissions and/or SRSp measurements, similar to a TRP, for example.

The WTRU may trigger the relay WTRU selection (e.g., reselection) procedure and/or select (e.g., reselect) a relay WTRU based on a positioning QoS. In examples, the WTRU may select a relay WTRU that may allow to meet a positioning accuracy requirement by providing suitable positioning configurations (e.g., PRS configurations, SRSp configurations) to the target WTRU. In examples, the WTRU may select a relay WTRU that may allow to meet the positioning latency requirement based on one or more attributes related to relaying such as hop-count to the network, loading at relay WTRU, size of measurement report, etc. In examples, the WTRU may select a relay WTRU that may allow, meet, or extend the validity conditions (e.g., area validity, time validity) associated with the preconfigured PRS/SRSp configurations. The WTRU may select a relay WTRU that may allow to use or extend the TA timer validity associated with SRSp configuration that may be provided to the WTRU, for example.

The WTRU may trigger the relay WTRU selection (e.g., reselection) procedure and/or select (e.g., reselect) a relay WTRU based on a priority. In examples, when multiple candidate relay WTRUs are available, the WTRU may select a relay WTRU with lowest load conditions with higher priority than other relay WTRUs with high load conditions. The load conditions may be associated with the number of remote/target WTRUs served by the relay WTRU, which may be determined by the target WTRU based on indications received from a relay WTRU or measurements over SL, for example. In examples, the WTRU may select a relay WTRU that may be stationary or mobile with low speed with a higher priority than another candidate relay WTRU that may be mobile with high speed. In examples, the WTRU may select a relay WTRU based on the order of priority configured/indicated by the network.

The WTRU may trigger the relay WTRU selection (e.g., reselection) and/or select (e.g., reselect) a relay WTRU based on a reception of indication from the network. In examples, the network (e.g., gNB or LMF) may be aware of the capability and attributes associated with positioning or one or more relay WTRUs (e.g., location information of relay WTRUs), the WTRU may receive information (e.g., ID) associated with the network selected relay WTRU based on a request message by the target WTRU. In examples, the WTRU may receive information/indication from the network of the candidate relay WTRUs that may be available for assistance/support for positioning. The WTRU may select a relay WTRU and indicate to the network the selected relay WTRU (e.g., ID), for example. The network or WTRU selected relay WTRU may be configured by the network to forward any of the positioning transmitting (e.g., posSIB, LPP messages, SRSp config) to/from the target WTRU, for example.

The WTRU may send positioning related indications/request messages to the relay WTRU. In examples, the WTRU (e.g., the target WTRU) may send indications/request messages over SL to a relay WTRU for indicating one or more of the following: a request for assistance data/configurations; a request for posSIB; a request for activating/deactivating positioning configurations; or measurements of Uu link and/or SL.

The WTRU may send indications/request messages over SL to a relay WTRU for indicating a request for assistance data/configurations. In examples, the WTRU may request for assistance data that may be associated with Uu-link based and SL-based positioning, including one or more (e.g., any) of PRS, SRSp or SL-PRS configurations and/or parameters, location information of relay WTRU, location information of TRPs, correction info, etc. In examples, the WTRU may send a request for a zone or positioning area specific assistance data, which may include cell/TRP IDs, PRS/SRSp configuration associated with (e.g., some) TRPs/cells. The request may be sent for new assistance data, for updating preconfigured assistance data, for a request for switching between different assistance data/configurations, or as an on-demand request, for example.

The WTRU may send indications/request messages over SL to a relay WTRU for indicating a request for posSIB. In examples, the WTRU may send a request for posSIB to relay WTRU by indicating the posSIB ID. In examples, the WTRU may send a request for area-specific posSIB by including the positioning area ID and posSIB ID. The WTRU may send an explicit or implicit request for timing information of the serving cell of the relay WTRU (e.g., SFN info, timing offsets, offsets/adjustments to apply to DFN) or one or more (e.g., any) of the neighbor cells detected by the WTRU (e.g., cell IDs).

The WTRU may send indications/request messages over SL to a relay WTRU for indicating a request for activating/deactivating positioning configurations. In examples, the WTRU may send a request to activate/deactivate any of the preconfigured SRSp, SL-PRS and PRS configurations/parameters. The WTRU may send the IDs/indexes of the configurations/parameters requested to be activated/deactivated, for example.

The WTRU may send indications/request messages over SL to a relay WTRU for indicating measurements of Uu link and/or SL. In examples, the WTRU may be configured to send measurement reports, including RSRP measurements of SSB/PRS received from serving cell or neighbor cell, RSRP measurements of SL transmissions (e.g., SL-PRS, discovery message, PSSCH), and CBR measurements of one or more configured resource pools associated with positioning.

The WTRU may send the indications/request messages when detecting any of the following triggering events/conditions: reception of indication from higher layers or NW; reception of indications/messages (e.g., discovery message) from relay WTRU on capability for assisting or supporting positioning (e.g., Uu link and/or SL measurements (e.g., for example, WTRU may be triggered to send requests/indications to relay WTRU when the RSRP measurements of SSB/PRS received from serving cell or neighbor cells are above/below one or more threshold values. The WTRU may send request/indications when the RSRP measurements of SL transmissions (e.g., SL-PRS) received from any of the anchor WTRUs or relay WTRU or the CBR measurements are above/below one or more threshold values)); detection of movement or change of location of target WTRU; or periodic with a configured periodicity. The WTRU may send the indications/request messages to a relay WTRU using any of on-demand SI, SLPP/RSPP, PC5-RRC, SL MAC CE, and SCI, for example. In examples, the WTRU may send measurement reports/location estimates to the relay WTRU and/or network.

In examples, the WTRU (e.g., target WTRU) may send positioning info/reports (e.g., location measurements/estimations) to the relay WTRU and/or network based on one or more of the measurements performed on the PRS received from one or more TRPs or measurements performed on an SL-PRS received from one or more anchor WTRUs and/or relay WTRU. In examples, the WTRU may send the positioning information based on a reporting configuration received in assistance data from the relay WTRU or network. The WTRU may send the positioning information/reports after completion of the measurements and/or upon detecting triggering events/conditions herein (e.g., a reception of request from network, periodic reporting, detection of errors, etc.), for example.

The positioning information/reports may be sent by the WTRU periodically or based on event triggers, in one or more of (e.g., any) of the following: Higher layer transmitting (e.g., in LPP, SLPP, RSPP), AS layer transmitting over SL to the relay WTRU (e.g., in PC5-RRC, MAC CE, SCI, PSSCH), or AS layer transmitting over Uu link to the network (e.g., in RRC, MAC CE, UCI, PUSCH). The positioning information sent by the WTRU may include one or more of the following: location information/measurements; an access node; SL positioning information; timing information; error information; positioning QoS; WTRU mobility/movement information; or prediction/interpolation information.

In examples, positioning information sent by the WTRU may include location information/measurements. In examples, the WTRU may send the determined/estimated WTRU location (e.g., coordinates, relative location with respect to a reference point/location) and/or measurements that may be used for determining/estimating WTRU location. The WTRU may send the location information using absolute values (e.g., normal coordinates) or truncated values (e.g., abbreviated coordinates), for example. The location information may be sent with (e.g., along with) the timing information (e.g., timestamps indicating when the measurements/estimations are performed) and/or the IDs/indexes of configurations applied during measurements including one or more of PRS/SL-PRS configurations, measurement time instances/windows, and separation criteria, for example. When sending timing information (e.g., timestamps) the WTRU may report absolute time (e.g., UTC), system time (e.g., SFN, DFN), or differential time (e.g., difference in the time with respect to previous/reference time instance/occasion), for example. In examples, the WTRU may send information on any other measurements and estimations, including measurements of GNSS transmissions (e.g., for estimating initial WTRU location), measurements made on RRM transmissions (e.g., CSI-RS, SSB) and an estimation of TA in addition to the PRS measurements.

In examples, positioning information sent by the WTRU may include an access node. In examples, the WTRU may send information on the access nodes/TRPs (e.g., IDs/indexes) used during positioning. The WTRU may send the timing information (e.g., timestamps) indicating the start/end time when using or switching to one or more of (e.g., any of) the access nodes, for example. In examples, the WTRU may send information associated with the one or more PRS configurations/parameters (e.g., IDs/indexes) used in association with the selection of one or more access nodes. In examples, the WTRU may send information (e.g., IDs, timing info/timestamps) on any reference units such as PRUs, reference points, and/or reference access nodes/anchor WTRUs/TRPs, when using the reference units for differential measurements (e.g., RSTD, differential timing/phase).

In examples, positioning information sent by the WTRU may include SL positioning info. In examples, when the WTRU is configured with SL positioning techniques (e.g., SL-TDOA, SL-AOD, SL-AOA, SL-RTT) using one or more anchor WTRUs, the WTRU may report one or more of the following: anchor WTRU IDs; reference time used (e.g., absolute time or relative time), where the time may be based on one or more of GNSS synchronization time, SFN provided by network, DFN provided based on which RSTD measurements/calculations may be made, for example; reference point used (e.g., location on the cell/beam transmitted by the anchor WTRUs and/or used by target WTRU), based on which location/TA estimates may be made, for example; SL-PRS configurations (e.g., IDs) used, including one or more resource pools/beams (e.g., resource set/resource/beam IDs), which may be associated with the anchor WTRUs; or ToA, RSRP and RSTD measurements made on the SL-PRS and/or timing information (e.g., timestamps) indicating when the measurements may be made.

In examples, positioning information sent by the WTRU may include timing information. In examples, the WTRU may indicate the reference timing information or timing/sync source (e.g., GNSS, SFN, DFN, timing offsets/adjustments with respect to the SFN/DFN) used for performing PRS/SL-PRS measurements.

In examples, positioning information sent by the WTRU may include errors information. In examples, the WTRU may indicate errors due to time/phase/power measurements (e.g., timing/phase error group IDs), and errors related to location of access nodes or anchor WTRUs. In examples, the WTRU may report detection and/or measurements of error sources (e.g., multipath, NLOS).

In examples, positioning information sent by the WTRU may include a positioning QoS. In examples, the WTRU may send information associated with the expected and/or achievable positioning QoS (e.g., accuracy, integrity, latency, power savings) with respect to the requirements/KPIs received from the network (e.g., LMF, gNB) or higher layers. The WTRU may report the QoS information (e.g., accuracy, latency, integrity) on a per-positioning technique and/or per-access node/anchor WTRU basis, for example.

In examples, positioning information sent by the WTRU may include WTRU mobility/movement information. In examples, the WTRU may send information on mobility states (e.g., stationary, mobile with low/high speed), mobility/movement attributes (e.g., speed, direction, distance travelled in direct/straight path), and/or trajectory information (e.g., list of locations and/or list of cells/TRPs/anchor WTRUs (e.g., IDs) detected by the WTRU over a time duration).

In examples, positioning information sent by the WTRU may include prediction/interpolation information. In examples, the WTRU may send the predicted/extrapolated location information/measurements (e.g., for time instances where measurements may not be made or missed) and/or the interpolated location information/measurements (e.g., estimations between two (2) or more time instances). The WTRU may send the timing information (e.g., timestamps) associated with prediction/interpolation, indicating the time instances/windows when the predictions/interpolations may be applied by the WTRU, for example. In examples, the WTRU may indicate the confidence level and/or uncertainty associated with the predicted/interpolated location information/measurements.

A WTRU may send differential positioning information (e.g., a delta) with respect to the information sent in (e.g., the previous) reporting instances, for example, to minimize the amount of reporting and/or transmission of positioning information. In examples, (e.g., the different types of) positioning information (e.g., location information determined via measurements/estimation, error info) may be associated with (e.g., different) priority values, where the priority values may be received by the WTRU as assistance data from the relay WTRU or network. In this case, the WTRU may apply (e.g., different) reporting periodicities or urgency levels for sending the positioning information based on the priority associated with the information type to be reported. In examples, the positioning information that includes a change value greater than a threshold with respect to previously reported information may be sent with higher periodicity or triggered with higher urgency level. Likewise, the WTRU may send information related to errors and/or change with respect to an expected trajectory of the mobile access nodes with higher periodicities and/or a higher urgency level, for example.

The WTRU may support DL-based positioning in OOC or partial coverage scenarios. In examples, the location information of the WTRU (e.g., target WTRU) may be determined where the WTRU may be in OOC or partial coverage, and at least one or more of the access nodes may be in OOC when using one or more of (e.g., any) DL-based positioning techniques (e.g., DL-TDOA, DL-AOD). The WTRU may have connectivity with the serving cell via a relay WTRU, for example. The WTRU may be able to receive PRS from the serving cell/TRP and neighbor cells/TRPs and perform measurements of PRS using assistance data received from the network (e.g., via a relay WTRU), irrespective of whether the WTRU may be able to receive the SSBs from any of the cells. The WTRU may receive the PRS from one or more (e.g., any) of the cells (e.g., serving cells and neighbor cells) but not the SSBs due to transmission scheme used for PRS for extending the coverage, which may be different than the transmission scheme used for SSBs that may limit the coverage, for example.

The target WTRU, which may have established connectivity with the network via a relay WTRU, may perform one or more of the following when supporting DL-based positioning: request for assistance data; determine PRS configurations/parameters; or transmit measurement reports/location info.

The WTRU may request assistance data, for example, while supporting DL-based positioning. In examples, the WTRU may send a request to the LMF (e.g., in an LPP message) for assistance data. The WTRU may include in the request one or more (e.g., any) of the following: relay WTRU information (e.g., ID, relative location/distance of relay WTRU), serving cell information (e.g., ID), detectable cells/TRPs (e.g., cell/TRP IDs, positioning area IDs), or initial location of WTRU (e.g., positioning area ID where the target WTRU may be located). The LMF may provide suitable PRS configurations (e.g., ref cell to use, TRPs/RSUs to use) relevant to relaying. In examples, the WTRU may send the request for assistance data to the relay WTRU (e.g., in SLPP/RSPP, PC5-RRC, MAC CE), for example. The WTRU may include in the request to relay WTRU similar information indicated in the request to the LMF (e.g., detectable TRPs/cells, initial location of WTRU, positioning area). In examples, the WTRU may send the request for assistance data to the network or relay WTRU based on one or more conditions including a capability of the relay WTRU for positioning, availability of assistance data (e.g., posSIB, area-specific PRS configurations) at the relay WTRU, positioning QoS (e.g., latency, accuracy), etc. The WTRU may determine PRS configurations/parameters when supporting DL-based positioning. In examples, the WTRU may determine/select the assistance data and/or PRS configurations/parameters from a set of candidates indicated by the relay WTRU/network based on (e.g., some) conditions including link conditions between WTRU and cells/TRPs transmitting PRS (e.g., RSRP measurements), positioning QoS (e.g., accuracy), distance to relay WTRU, priority, etc. The WTRU may perform measurements of the PRS received from TRPs outside the coverage of one or more serving cells based on assistance data provided by the relay WTRU or network and/or PRS configurations selected by the WTRU, for example.

The WTRU may transmit measurement reports/location information when supporting DL-based positioning. In examples, the WTRU may indicate in the measurement report/location information sent to the network (e.g., LMF, gNB) the timing info/timestamps aligned with the SFN of the serving of reference cell. In the measurement report to LMF, timestamps aligned with SFN information of the serving/reference cell may be included.

The WTRU may support UL-based positioning in OOC or partial coverage techniques. In examples, the location information of a WTRU (e.g., target WTRU) may be determined in techniques where the WTRU may be in OOC or partial coverage and at least one or more of the access nodes (e.g., TRPs/cells) may be in OOC when using one or more of (e.g., any of) UL-based positioning techniques (e.g., UL-TDOA, UL-AOA). The location of the WTRU may be determined based on the UL transmissions sent by the WTRU and/or measurements made by one or more access nodes, including the serving cell/TRP and neighbor cells/TRPs.

The UL transmissions, as described herein, may include one or more of the following: one or more SRS or SRSp (SRS for positioning) transmissions that may be sent by WTRU using any of SRS/SRSp resources, resource sets, beams, frequency layers and configurations; or one or more RACH preambles, sequences, partitions, and resources, which may be sent by WTRU during a RACH occasion.

In examples, the WTRU may establish connectivity with the serving cell via a relay WTRU. For transmitting UL transmissions for positioning (e.g., SRSp), the WTRU may use resources and/or configurations that may be received from the network (e.g., gNB, LMF) and/or relay WTRU. Features described herein may facilitate that access nodes may (e.g., accurately and reliably) perform measurements of UL transmissions and subsequently determine the location of the WTRU (e.g., at the gNB, LMF), the WTRU may apply certain adjustments/corrections to the UL transmissions according to the timing information and/or TA value estimated by the WTRU or indicated by the relay WTRU/NW, for example. The measurement reports including the measurements made by the access nodes may be forwarded to an anchor base station, gNB, BBU or CU in RAN or to the AMF or LMF, for example, for determining the WTRU location.

A target WTRU may established connectivity with the network via a relay WTRU. The target WTRU may perform any of the following when supporting UL-based positioning: request for SRSp configurations/parameters; determine SRSp configurations/parameters to use during SRSp transmission; or perform SRSp transmissions.

The target WTRU may request for SRSp configurations/parameters when supporting UL-based positioning. In examples, the target WTRU may send a request to a relay WTRU and/or network (e.g., the gNB) the SRSp configurations/parameters when detecting (e.g., any of the) triggering events/conditions as described herein. The target WTRU may determine SRSp configurations/parameters to use during SRSp transmission when supporting UL-based positioning. In examples, the WTRU may determine/select (e.g., any of the) SRSp configurations/parameters from a set of candidates indicated by the relay WTRU or NW, based on some conditions including measurements of link conditions between the WTRU and cells/TRPs that may perform SRSp measurements, distance to the relay WTRU, priority, etc. In examples, the WTRU may send an indication to the relay WTRU or network, indicating the selected SRSp configuration/parameters.

The target WTRU may perform SRSp transmissions when supporting UL-based positioning. The WTRU may initiate/stop SRSp transmissions upon receiving from the relay WTRU or network, the SRSp configuration, and/or an activation/deactivation indication (e.g., via SL MAC CE, SCI), for example. The WTRU may release/update an existing SRSp configuration upon receiving a release/update indication from relay WTRU or NW, for example.

The relay WTRU may support relay WTRU assisted positioning. The WTRU may be configured to support positioning of target WTRU(s). In examples, the WTRU (e.g., relay WTRU) may be configured for assisting or supporting with the positioning of one or more target WTRUs when using one or more of the following modes: transparent mode or server mode.

The WTRU may be configured for assisting or supporting with the positioning of one or more target WTRUs when using transparent mode: In examples, a relay WTRU (e.g., an L2 relay) may forward (e.g., any of the) positioning transmitting (e.g., LPP messages, RRC messages) between a target WTRU and the network (e.g., gNB, LMF). The relay WTRU may be configured with an adaptation layer that may allow one or more of the following: map the data (e.g., positioning transmitting) received from network over Uu link to the target WTRU when transmitting over SL, or map the data received from the target WTRU over SL to Uu link when transmitting the data to the network, for example.

In examples, the relay WTRU may forward any assistance data and/or positioning configurations (e.g., PRS, SRSp, SL-PRS configurations) received from the network to one or more target WTRUs and/or anchor WTRUs for supporting Uu-link based and/or SL based positioning at the target WTRUs. The assistance data and/or positioning configurations may be transmitted via broadcast (e.g., in posSIB), groupcast, or unicast (e.g., LPP, SLPP, RSPP messages) transmission modes, for example. The relay WTRU may forward the measurement reports received from target WTRUs/anchor WTRUs to NW.

In examples, the relay WTRU may provide, to the target WTRU, timing information including: SFN of the serving cell, offsets/adjustments to DFN, and/or offsets/adjustments to TA values, such that the target WTRU may (e.g., be able to) perform DL-PRS measurements and/or SRSp transmissions. Such timing information along with posSIB/PRS configurations, may be transmitted periodically with a configured periodicity upon receiving a one or more of a request (e.g., on-demand SI request) from a target WTRU or when receiving an indication from the gNB. The relay WTRU may transmit the posSIB and/or timing information periodically with a higher periodicity than the default periodicity when detecting (e.g., via discovery) a certain number of target WTRUs in a proximity that may perform positioning.

In examples, the relay WTRU may have the capability of performing SL-based positioning. In this case, the relay WTRU may be configured to perform transmissions of SL-PRS over SL or measurements of SL-PRS received over SL. The WTRU may send measurement reports associated with the SL-PRS measurements to a network (e.g., via LPP, RRC transmitting). A relay WTRU may perform SL-PRS transmissions/measurements, for example, similar to an anchor WTRU in SL-based positioning. In examples, the relay WTRU may be used for supporting SL-based positioning in partial coverage scenarios.

In examples, the relay WTRU may support Uu-based positioning. In examples, the relay WTRU may be configured to perform transmissions of PRS to target WTRU(s) or measurements of SRSp received from target WTRU(s). The WTRU may be configured for assisting or supporting with the positioning of one or more target WTRUs when using server mode. In examples, the relay WTRU may be configured to operate as a local location server (e.g., local LMF) for supporting the positioning of one or more target WTRUs. When operating in server mode, the functionalities that may be supported by a relay WTRU may include one or more of the following, for example: initiate/trigger the positioning of target WTRU, determine the positioning technique (e.g., Uu-link based, SL-based, hybrid Uu+SL based) for the target WTRU, configure positioning resources (e.g., PRS, SRSp, SL-PRS) in the target WTRU, coordinate with one or more anchor WTRUs for positioning of the target WTRU(s) when supporting SL-based positioning, calculate the location of the target WTRU (e.g., based on measurement reports received from the target WTRU, and/or anchor WTRUs) and report the positioning information of the target WTRU (e.g., measurement reports/location) to the network. When operating in server mode, the relay WTRU may use one or more (e.g., any) of higher layer transmitting (e.g., SLPP, RSPP) or SL AS layer transmitting (e.g., PC5-RRC, MAC CE, SCI, PSSCH) when transmitting/receiving any transmitting/messages to/from target WTRU.

The WTRU may determine the positioning technique and/or assistance information to provide to target WTRU(s). In one solution, the WTRU (e.g., relay WTRU) may determine/select or assist in determining the positioning (e.g., Uu-link based, SL-based, hybrid Uu+SL based) for one or more target WTRU(s) based on a criteria as described herein. The criteria, including one or more parameters/threshold values association with the positioning techniques, may be configured by the network (e.g., via RRC or LPP transmitting). In examples, the Uu-link based positioning that may be selected by the target WTRU may include one or more of DL-TDOA, DL-AOD, UL-TDOA, UL-AOA and multi-RTT. The SL-based positioning that may be selected for the target WTRU may include one or more of SL-TDOA, SL-AOA, SL-AOA, SL-RTT, for example. The relay WTRU may be triggered for determining/selecting a positioning technique for a target WTRU when receiving a request indication (e.g., location request) from the target WTRU, network or from higher layers (e.g., MO-LR, MT-LR, NI-LR).

In examples, the relay WTRU may determine the assistance data and/or positioning configurations/parameters (e.g., PRS, SRSp, SL-PRS configurations) to provide to the target WTRU for supporting one or more of the (e.g., any of the) positioning techniques. In examples, the relay WTRU may determine the assistance data and/or positioning configurations based on the positioning technique determined/selected for the target WTRU. In examples, the relay WTRU may determine the assistance data and/or positioning configurations upon receiving a request indication from the target WTRU, for example.

In examples, the relay WTRU may retransmit the assistance data/positioning configurations or transmit updated assistance data/positioning configurations to target WTRU(s) when detecting changes to the measurements (e.g., Uu link, SL measurements), determining changes to measurements that may be provided by the target WTRU (e.g., RSRP or RTT measurement of SL-PRS is above/below threshold values), receiving indications from the target WTRU (e.g., movement, detection of new cell/TRP, detection of blockage) and receiving indications from the network (e.g., update to PRS, SRSp, SL-PRS configurations).

In examples, the relay WTRU may not (e.g., decide not to) provide (e.g., any) assistance data or positioning configurations (e.g., PRS, SRSp, SL-PRS configurations) to a target WTRU when detecting one or more of the (e.g., any of the) following conditions: distance determined to a target WTRU to be above a distance threshold; high number of target WTRUs that may be supported for positioning (e.g., above a threshold value); data transmissions may be prioritized over positioning; handing high data traffic load (e.g., above a load threshold value); low battery life/power; or criteria for positioning a target WTRU may not be met (e.g., RSRP measurements of Uu link and/or SL made by a relay WTRU or reported by the target WTRU may be above/below (e.g., some) RSRP threshold values. When any of such conditions are detected, the relay WTRU may send a rejection indication or a prohibit indication (e.g., with a prohibit timer) to the target WTRU. The relay WTRU may send an explicit or implicit indication to the target WTRU to receive the assistance data, positioning configurations or posSIB from the neighbor cells (e.g., instead of the serving cell or relay WTRU) when such conditions are detected, for example.

In examples, the relay WTRU may send an indication to the network (e.g., gNB, LMF) when determining positioning for the target WTRU and/or when sending any assistance data and/or positioning configurations/resources to the target WTRU. Such an indication may be sent by the relay WTRU to the network in LPP transmitting, RRC, MAC CE or UCI, for example. In examples, when sending SRSp configuration and/or an SRSp activation/deactivation indication to the target WTRU, the relay WTRU may send an indication to the network, for example, for triggering the TRPs to perform measurements of the SRSp transmitted by the target WTRU.

The criteria configured in a relay WTRU and used by the relay WTRU for determining the positioning technique for the target WTRU and/or the assistance data/positioning configurations to provide to the target WTRU(s) may include one or more of the following: measurements associated with Uu-link and/or SL; an indication from the network or the target WTRU; ranging information (e.g., distance/direction); positioning information of the target WTRUs; positioning QoS; number of target WTRUs; availability/reliability of resources for SL-based positioning; or priority.

In examples, the criteria configured in the relay WTRU may include measurements that may be associated with Uu-link and/or SL. In examples, the relay WTRU may determine to use Uu-link based positioning (e.g., DL-based, UL-based, multi-RTT) for a target WTRU and/or provide the associated assistance data/configurations if the RSRP measurements of the SSB/PRS/CSI-RS received from the TRPs at target WTRU (e.g., including serving cell/TRP and neighbor cells/TRPs) is above/below one or more RSRP threshold values. The WTRU may determine to use Uu-link positioning if the number of TRPs with an RSRP is above a threshold value and/or with LOS conditions are above a TRP count threshold value, for example. The relay WTRU may decide on Uu-link based positioning for the target WTRU based on the measurement reports provided by the target WTRU, for example.

In examples, the relay WTRU may determine to use SL-based positioning (e.g., SL-TDOA) for a target WTRU and/or provide the associated assistance data/configurations if the RSRP measurements made by the target WTRU of SL transmissions (e.g., SL-PRS, discovery messages, PSSCH) received from one or more anchor WTRUs (e.g., including/excluding relay WTRU) is above/below one or more RSRP threshold values (e.g., RSRP of SL PRS is above an RSRP threshold). The WTRU may determine to use SL-based positioning if the number of anchor WTRUs with an RSRP are above a threshold value and/or with LOS conditions are above an anchor WTRU count threshold value, for example. The relay WTRU may decide on SL based positioning for the target WTRU based on one or more of the (e.g., any of the) measurement reports provided by the target WTRU, measurement reports provided by (e.g., other) anchor WTRUs and own measurements of SL transmissions received from the target WTRU, for example. In examples, the relay WTRU may determine to use hybrid Uu+SL based positioning for the target WTRU and provide the associated assistance data/configurations when one or more of the following occurs: an RSRP of the SSB/PRS/CSI-RS received from one or more TRPs at target WTRU is above/below some RSRP threshold values; an RSRP of the SL transmissions (e.g., SL-PRS) received from one or more anchor WTRUs at the target WTRU is above/below (e.g., some) RSRP threshold values (e.g., a second RSRP-a first RSRP is between thresholds (e.g., two thresholds); or the total number consisting of the number of TRPs with an RSRP above a threshold value and the number of anchor WTRUs with an RSRP above a threshold value are above a node count threshold value. In examples, the criteria configured in the relay WTRU may include an indication from the network or target WTRU. In examples, the WTRU may use Uu-link based, SL-based or hybrid Uu+SL based positioning and/or forward the associated assistance data and/or positioning configurations (e.g., PRS, SRSp, SL-PRS configurations) based on an indication of the positioning received from the network (e.g., in LPP, RRC, MAC CE, DCI) or from the target WTRU (e.g., in SLPP/RSPP, PC5-RRC, MAC CE, SCI).

In examples, the criteria configured in the relay WTRU may include ranging information (e.g., distance/direction). In examples, the relay WTRU may send assistance data and/or positioning configurations (e.g., for a positioning technique selected for the target WTRU) based on whether the distance to the target WTRU is above/below one or more distance threshold values. The distance to the target WTRU may be determined from one or more of the RSRP or RTT measurements of the SL transmissions (SL-PRS, discovery, PSSCH) or estimated based on the TA values used for SL transmissions. In examples, the relay WTRU may send an SL-PRS configuration to the target WTRU when the distance to the target WTRU is determined to be within a first distance threshold range. The relay WTRU may send a PRS configuration or SRSp configuration to the target WTRU when the distance to the target WTRU is determined to be within a second distance threshold range. In examples, the relay WTRU may send suitable assistance data and/or positioning configurations when determining that the target WTRU is located in a particular direction from the relay WTRU within one or more direction/orientation angle threshold values). The direction of the target WTRU may be determined based on the Rx beam direction used at the relay WTRU or SL transmissions power/phase received from the target WTRU when using multi-antenna array at the WTRU, for example.

In examples, the criteria configured in the relay WTRU may include positioning information of the target WTRUs. In examples, the relay WTRU may send suitable assistance data and/or positioning configurations to a target WTRU (e.g., target WTRU or relay WTRU) based on the location of the target WTRU. The location of the target WTRU may be determined to be different granularities, including cell, zone, or positioning area (e.g., consisting of a list of cells), for example. In examples, the relay WTRU may provide a suitable PRS configuration or area-specific posSIB to a target WTRU when the target WTRU may be estimated to be located in the positioning area/zone associated with the PORS config/posSIB.

In examples, the relay WTRU may send (e.g., to the target WTRU) the positioning configurations (e.g., SL-PRS, SRSp configurations) associated with the positioning technique selected for the target WTRU and with positioning area/zone where the target WTRU may be located. Such forwarding of the positioning configurations may be done by the relay WTRU based on estimation of the initial location of the target WTRU using measurements over SL (e.g., RSRP measurements of SL transmissions) to determine the zone of the target WTRU (e.g., for a 5 m×5 m zone size resolution). The relay WTRU may select the SL-based positioning technique for the target WTRU and forward the SL-PRS configurations for performing SL-RTT transmissions when determining that the target WTRU may be located in the zone the relay WTRU may be located. The relay WTRU may select UL-based positioning technique for the target WTRU and forward the SRSp configuration for performing UL-SRSp transmissions (for UL-TDOA) when determining that the target WTRU may be located in a different zone than the relay WTRU (e.g., the number of zones between the relay WTRU and the target WTRU may be above a zone count threshold or a distance between the relay WTRU, and the target WTRU may be above a distance threshold) for example.

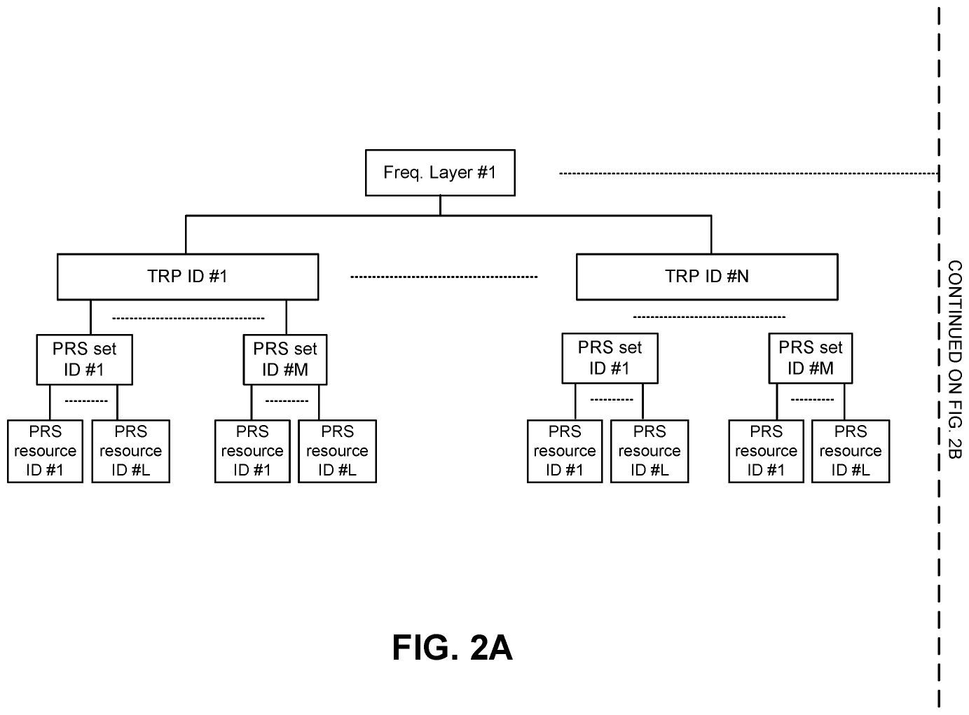

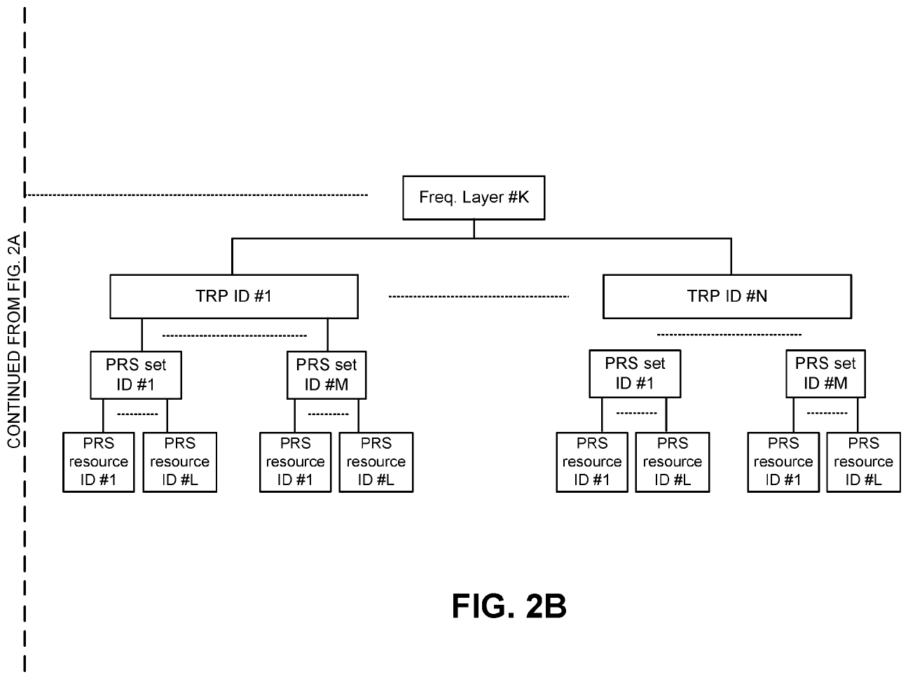

In examples, the relay WTRU may determine to provide a subset of a PRS configuration to the target WTRU. In examples, the relay WTRU and the target WTRU may be preconfigured with a PRS configuration (e.g., frequency layer). The relay WTRU may provide PRS configurations associated with the preconfigured PRS configuration (e.g., TRP, PRS periodicity). The configuration of PRS may be based on the PRS hierarchy, and an example of the PRS hierarchy may be shown in FIG. 2. In examples, both the relay WTRU and the target WTRU may be preconfigured with frequency layer #1. Based on a condition, the network WTRU may provide PRS configurations to the target WTRU, which may be associated with the frequency layer #1 (e.g., TRP IDs. PRS transmission periodicity). In examples, PRS and SRS or SRSp may be used interchangeably as described herein.

In examples, the criteria configured in the relay WTRU may include a positioning QoS. In examples, the relay WTRU may determine and/or provide suitable positioning configurations (e.g., PRS, SRSp, SL-PRS) based on an accuracy requirement associated with the positioning of the target WTRU. In examples, the relay WTRU may provide to the target WTRU with an SRSp configuration (e.g., high density resources) when the accuracy requirement may be above a threshold value and may provide an SRSp configuration (e.g., low density resources) when the accuracy requirement may be below the threshold.

In examples, the criteria configured in the relay WTRU may include a number of target WTRUs. In examples, the relay WTRU may determine the positioning and/or the positioning configurations to provide to a target WTRU based on the number of target WTRUs that may be configured with the positioning technique and/or provided with the positioning configurations. In examples, the relay WTRU may decide to provide an SL-PRS configuration to a target WTRU instead of a PRS configuration when the number of target WTRUs provided with the PRS configuration are above a configured threshold value.

In examples, the criteria configured in the relay WTRU may include an availability/reliability of resources for SL-based positioning. In examples, the relay WTRU may (e.g., select to) use SL-based positioning for a target WTRU upon identifying the availability of resources for SL positioning (e.g., the CBR or RSRP may be above/below threshold values) based on measurements over SL (e.g., RSRP, RSSI, CBR measurements) or an indication from the target WTRU, anchor WTRUs, or network. If the sufficient resources or anchor WTRUs for SL-based positioning are not available and TRPs for supporting Uu-link based positioning are available, the relay WTRU may determine to use Uu-based positioning for the target WTRU, for example.

In examples, the criteria configured in the relay WTRU may include a priority. In examples, the relay WTRU may be configured with (e.g., some) priority values associated with assisting/supporting positioning a target WTRU and/or supporting data traffic relaying. The relay WTRU may decide whether to provide assistance data/positioning configurations (e.g., posSIB) to target WTRU or perform data relaying based on the priority values. In examples, the WTRU may be configured with supporting transmissions/measurements of SL-PRS, and the relay WTRU may support SL-based positioning when the associated priority may be higher than that of data relaying/transmissions.

In examples, the relay WTRU may count the number of events/instances where support for positioning (e.g., providing assistance data/positionings configurations, performing SL-PRS transmissions/measurements) may be dropped in favor of supporting data relaying/transmissions due to lower priority for positioning. The relay WTRU may support positioning when the number of events/instances may exceed a threshold value.

FIG. 2 illustrates an example of a PRS configuration hierarchy. A relay WTRU may provide positioning configurations (e.g., SRSp configuration PRS configuration posSIB) to a target WTRU.

In examples, a relay WTRU may be configured to provide positioning configurations (e.g., SRSp configuration PRS configuration posSIB) to a target WTRU based on and the estimation of the initial location information of the target WTRU. In examples, the estimation of the initial location information of the target WTRU may be done based on SL measurements (e.g., RSRP of SL-PRS) to identify the zone or positioning area of the target WTRU. The relay WTRU may forward, to the target WTRU, the positioning configuration associated with the zone/positioning area where the target WTRU may be located.

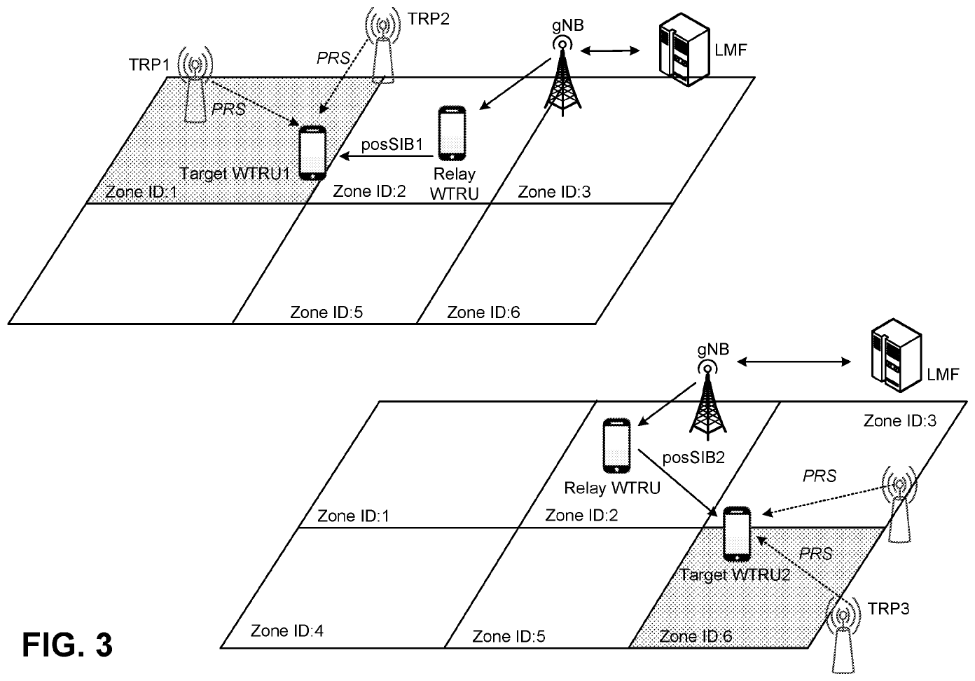

FIG. 3 illustrates zone-area-specific positioning configurations. The Relay WTRU may provide zone/area-specific positioning configurations (e.g., posSIB) to a target WTRU based on the estimation of the zone where the target WTRU may be located. In examples, the relay WTRU transmits posSIB1 (e.g., left of FIG. 3) for a target WTRU1 located in zone1. The relay WTRU transmits posSIB2 (e.g., right of FIG. 3) for a target WTRU2 located in zone 2.

An example technique applied at the relay WTRU for assisting with providing positioning configuration to a target WTRU may include the following. In examples, configuration information may be received from the network. The configuration information may include one or more of: one or more RSRP threshold values associated with distance and/or direction of the target WTRU; an association between the RSRP threshold values associated with distance and/or direction and zones (IDs); or one or more positioning configurations (e.g., PRS configurations, SRSp configurations, posSIB) associated with zones (IDs).

In examples, measurements of SL transmissions (e.g., SL-PRS) transmitted by the target WTRU may be performed. In examples, the relay WTRU may trigger the transmission of an SL-PRS in the target WTRU by providing the SL-PRS configuration and/or sending an indication for initiating the SL-PRS transmission.

In examples, the distance and/or direction of the target WTRU (e.g., with respect to a reference direction such as the direction of the relay WTRU) based on the SL measurements may be determined. In examples, the distance to target WTRU may be estimated based on path loss and RSRP measured over the SL transmissions (e.g., SL-PRS, PSSCH, CSI-RS, DM-RS) transmitted by the target WTRU. The distance to the target WTRU may be estimated based on the RTT of SL-PRS of other SL transmissions sent by the relay WTRU and target WTRU. The target WTRU may be estimated to be within a certain distance if the RSRP of SL-PRS is within an RSRP threshold range, for example. In examples, the direction of the target WTRU with respect to a reference direction (e.g., geographic north, relay WTRU direction) may be estimated based on an Rx beam direction used by the relay WTRU for receiving the SL transmissions (e.g., SL-PRS, PSSCH) transmitted by the target WTRU, measurements of power/phase of the SL transmissions sent by the target WTRU when using a multi-antenna array at the relay WTRU, or based on an indication of direction transmitted by the target WTRU, for example. The direction of the target WTRU may be estimated to be within a certain angle range/width (e.g., +10 degrees, −10 degrees) with respect to a reference direction (e.g., geographic north, direction of WTRU) if the RSRP of the SL transmissions received using an Rx beam is within an RSRP threshold range, for example.

In examples, the zone (e.g., ID associated with the zone) where the target WTRU may be located may be determined. In examples, the relay WTRU may determine the zone of the target WTRU based on the determined distance and/or direction of the target WTRU and association information between RSRP threshold values associated with the distance and/or direction and zones (e.g., IDs associated with zones). In examples, the relay WTRU may determine the zone of the target WTRU based on an indication received from the target WTRU indicating the zone where the target WTRU may be located.

In examples, the positioning configuration to provide to the target WTRU based on the zone where the target WTRU is located and the association information between the positioning configuration and zones may be determined. In examples, the relay WTRU may determine the type of the positioning configuration(e.g., PRS configuration SRSp, posSIB) to provide to the target WTRU based on a request/indication received from the target WTRU. In examples, the positioning technique to support may be determined by the target WTRU and/or the target WTRU may send in the request/indication (e.g., on-demand SI request) to the relay WTRU the type of the positioning configuration(e.g., ID/index) associated with the selected positioning technique. In examples, when receiving a request from a target WTRU (e.g., on-demand SI request), the relay WTRU may forward the posSIB associated with a zone to the target WTRU based on the zone where the target WTRU may be located. In examples, the relay WTRU may select the positioning technique for positioning the target WTRU and/or may determine the positioning configuration to provide to the target WTRU based on one more (e.g., preconfigured) conditions, as described herein.

In examples, the determined positioning configuration may be transmitted to the target WTRU over SL. In examples, the relay WTRU may transmit the positioning configuration to target WTRU via dedicated transmitting (e.g., in SLPP/RSPP, PC5-RRC, MAC CE, SCI) or via broadcast (e.g., in posSIB). In examples, the relay WTRU may transmit to the target WTRU other assistance data (e.g., location information of TRPs) and/or timing information (e.g., SFN, offset values to DFN) based on the type of the positioning configuration determined to be transmitted. In examples, the relay WTRU may transmit an indication (e.g., in RRC, MAC CE, UCI) to the gNB for indicating the transmission of the positioning configuration (ID) to the target WTRU.

A relay WTRU may assist in the triggering of UL-SRSp transmission at the target WTRU. In examples, a relay WTRU may be configured to activate/deactivate SRSp transmission at a target WTRU based on one or more preconfigured conditions. In examples, the conditions may include distance between the relay WTRU and the target WTRU and validity conditions (e.g., TA timer associated with SRSp config). Depending on whether the conditions are met, a relay WTRU may transmit to the target WTRU an indication to activate or deactivate SRSp transmission.

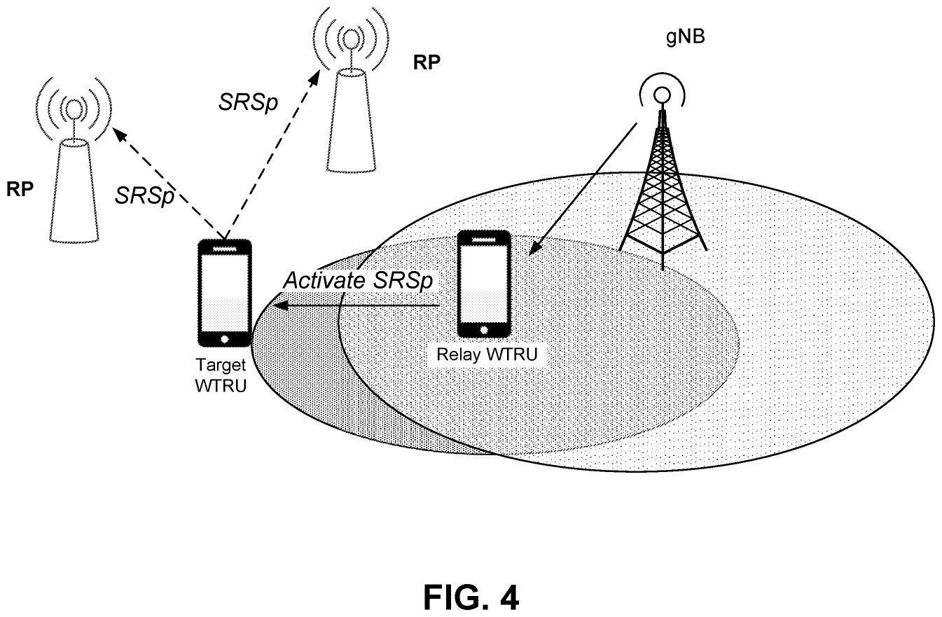

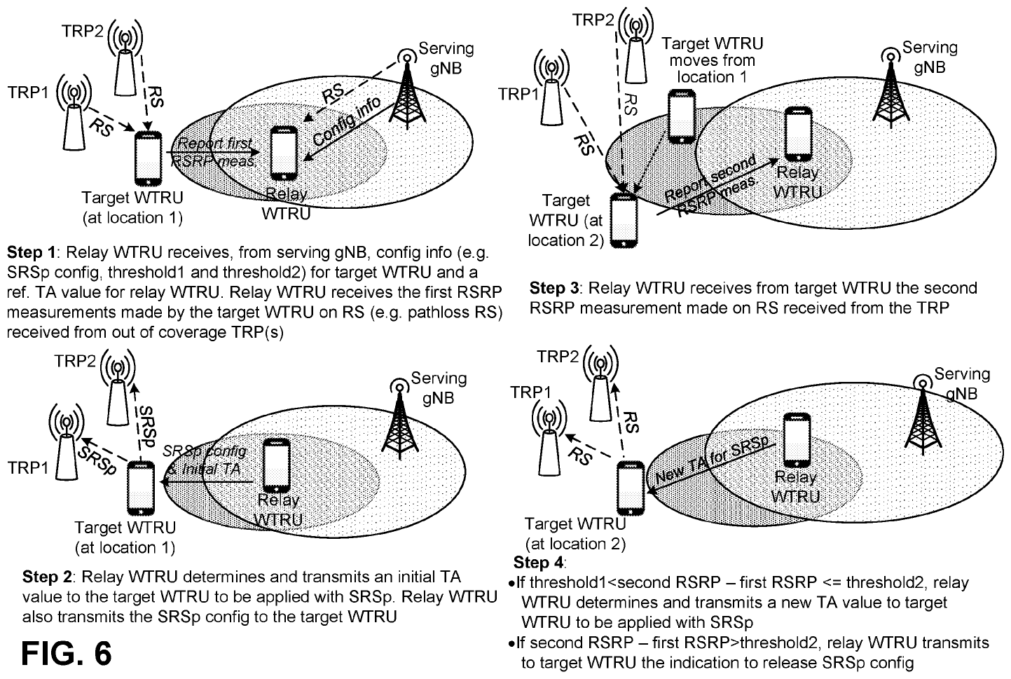

FIG. 4 illustrates an example wherein the relay WTRU (e.g., a first WTRU) may trigger the activation/deactivation of SRSp transmission at a target WTRU (e.g., a second WTRU) which may be located out of coverage (OOC) (see also FIG. 6). The triggering of SRSp transmission may be done by the relay WTRU based on conditions associated with validity of SRSp configuration and/or relative location of target WTRU to the relay WTRU. The SRSp transmitted by the WTRU may be measured by one or more reception points (RPs) (e.g., transmission reception points (TRPs) in the network (see FIG. 6).

Example features applied at the relay WTRU for triggering of SRSp transmission at the target WTRU may include one or more of the following. In examples, configuration information may be received from the network, which may include one or more of: a first threshold (e.g., the SL distance threshold1, a second threshold (e.g., distance threshold2); an SRSp configuration; or validity condition associated with the SRSp configuration (e.g., TA timer (e.g., a first TA value) at the relay WTRU) (e.g., see also FIG. 6).

The relay WTRU may transmit the SRSp configuration to the target WTRU. In examples, the SRSp configuration transmitted to the target WTRU may be associated with the zone/positioning area where the target WTRU may be located. The relay WTRU may determine the zone/positioning area of the target WTRU based on the SL measurements of SL transmissions received from target WTRU and/or preconfigured association information between the SRSp configuration and the zone/positioning area, for example. In examples, the SRSp configuration may be received from the gNB and transmitted (e.g., transmitted transparently) to the target WTRU.

In examples, measurements over SL may be performed (e.g., see FIG. 6; an RSRP associated with the target WTRU or RTT measurements of SL-PRS or SL channels) and the distance to the target WTRU may be determined based on the SL measurements. If the distance to the target WTRU is above an SL distance threshold1, below a distance threshold2, and a validity condition is met (e.g., TA timer at relay WTRU is running), the relay WTRU may perform one or more of the following.

If the distance to the target WTRU is above an SL distance threshold1, below a distance threshold2, and a validity condition is met (e.g., TA timer at relay WTRU is running), the relay WTRU may determine a second TA value for the target WTRU to use with SRSp transmission and send the second TA value to the target WTRU. The determination of the second TA value may be based on the RSRP measurements and the first TA value (e.g., see FIG. 6).

If the distance to the target WTRU is above an SL distance threshold1, below a distance threshold2, and a validity condition is met (e.g., TA timer at relay WTRU is running), an indication to the network (e.g., gNB) on triggering SRSp transmission at the target WTRU may be transmitted by the relay WTRU. In examples, the indication to network may be transmitted in higher layer transmitting (e.g., LPP) or AS layer transmitting (e.g., RRC, MAC CE or UCI). In examples, the indication may include one or more of the following: an SRSp configurationID, an SRSp triggering cause (e.g., IDs of detected conditions), timing information (e.g., timestamp) of when the SRSp transmission is activated/triggered, etc.

If the distance to the target WTRU is above an SL distance threshold1, below a distance threshold2, and a validity condition is met (e.g., TA timer at relay WTRU is running), an SRSp activation indication and/or indication of the second TA value (e.g., in PC5-RRC, SL MAC CE, SCI) may be transmitted to the target WTRU (e.g., the activation indication may include the second TA value) (e.g., see FIG. 6).

If the distance to the target WTRU is above an SL distance threshold1, below a distance threshold2, and a validity condition is met (e.g., TA timer at relay WTRU is running), and if SRSp is previously activated and the validity condition is not met (e.g., TA timer at relay WTRU is expired), an SRSp deactivation indication (e.g., in PC5-RRC, SL MAC CE, SCI) may be transmitted to the target WTRU. In examples, the indication to gNB may include an SRSp configuration ID, an SRSp triggering cause (e.g., IDs of detected conditions), timing information (e.g., timestamp) of when SRSp transmission is deactivated, etc.

If a distance to the target WTRU is above a distance threshold2, and/or a validity condition is not met (e.g., TA timer at relay WTRU is expired), an indication to release SRSp (e.g., in PC5-RRC, SL MAC CE, SCI) may be transmitted by the relay WTRU to the target WTRU (see FIG. 6).

The relay WTRU may assist in the triggering of SRSp and SL-PRS transmission at the target WTRU (e.g., see FIGS. 4-6). In examples, the relay WTRU may be configured to assist with hybrid positioning (e.g., Uu+SL based positioning) for a target WTRU when a certain condition (e.g., RSRP measurement of serving cell's SSB) for triggering UL-SRSp and SL-PRS transmission at target WTRU may be met. Depending on whether the condition may be met, the relay WTRU may transmit to target WTRU an indication to activate/deactivate SL-PRS and/or UL-SRSp transmission.

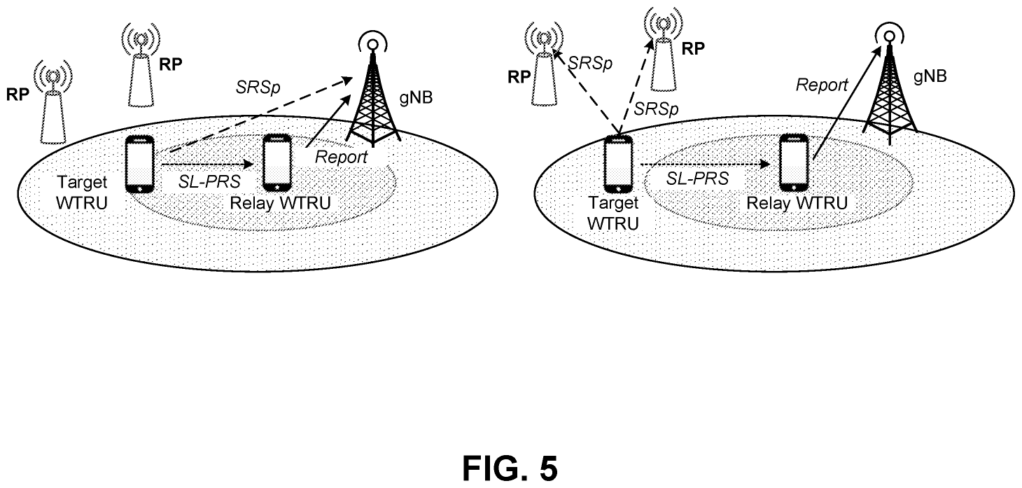

FIG. 5 illustrates an example wherein a relay WTRU may assist with hybrid positioning (e.g., Uu+SL) when a certain condition for triggering SRSp and SL-PRS transmission at target WTRU may be met. If the condition (e.g., RSRP measurement of serving cell's SSB) is met (e.g., the setup illustrated on left side of FIG. 5), the relay WTRU may transmit to the target WTRU an indication to activate the SL-PRS transmission (e.g., via SL MAC CE). If the condition is not met (e.g., setup illustrated on right side of FIG. 5), the relay WTRU may provide a UL-SRSp configuration and an indication to activate the UL-SRSp and an SL-PRS transmission to trigger hybrid positioning.

A relay WTRU may transmit to a target WTRU an indication to activate/deactivate SL-PRS and/or UL-SRSp transmission as described herein. A relay WTRU may receive configuration information from the network. The configuration information may include one or more of the following: an SL-PRS configuration for target a WTRU; an SRSp configuration for a target WTRU; or an RSRP threshold1 (upper bound) and threshold2 (lower bound).

The relay WTRU may transmit an SL-PRS configuration (e.g., via PC5-RRC, MAC CE, SCI) to the target WTRU. In examples, a measurement report (e.g., including RSRP measurements of OOC node(s) or SSB of serving cell) of measurements made by target WTRU may be received (e.g., by the relay WTRU) from the target WTRU.

If the RSRP measurements received from the target WTRU are below the RSRP threshold1 and above the RSRP threshold2 (e.g., target WTRU has poor Uu link with serving cell), one or more of the following may occur. An SL-PRS activation indication (e.g., in PC5-RRC, SL MAC CE, SCI) may be transmitted to the target WTRU. Measurements (e.g., RSRP or RTT) of SL-PRS received from target WTRU may be performed. A measurement report of SL-PRS measurements may be transmitted to the network. The measurement report may include one or more of (e.g., any of) an ID of the target WTRU, time of arrival (timestamp), RSRP measurements, an RTT measurements of an SL-PRS. The measurement report may be transmitted in higher layer transmitting (e.g., LPP) or AS layer transmitting (e.g., RRC, MAC CE, UCI).

In examples, if the RSRP measurements sent by the target WTRU are below the RSRP threshold2 (e.g., the target WTRU may have no Uu link), one or more of the following may occur. The SRSp configuration (e.g., in PC5-RRC, SL MAC CE, SCI) may be transmitted to the target WTRU. The relay WTRU may transmit the timing information (e.g., SFN, offset values to DFN) or TA value to use when transmitting SRSp. An indication may be transmitted to the network (e.g., gNB) on triggering SRSp and SL-PRS transmission at the target WTRU. The indication to network may be transmitted in higher layer transmitting (e.g., LPP) or AS layer transmitting (e.g., RRC, MAC CE or UCI). The indication may include one or more of an SRSp configuration ID, SL-PRS/SL-PRS configuration ID, SRSp/SL-PRS triggering cause (e.g., IDs of detected conditions), timing information (e.g., timestamp) of when the SRSp/SL-PRS transmission may be activated/triggered, etc. An SRSp activation indication and an SL-PRS activation indication (e.g., in PC5-RRC, SL MAC CE, SCI) may be transmitted to the target WTRU. A measurement report of SL PRS measurements may be transmitted to the network. In examples, the measurement report may include one or more of an ID of the target WTRU, time of arrival (timestamp), RSRP measurements, or RTT measurements of SL-PRS. In examples, the measurement report may be transmitted in high (e.g., higher) layer transmitting (e.g., LPP) or AS layer transmitting (e.g., RRC, MAC CE, UCI).

FIG. 6 illustrates an example wherein a relay WTRU may assist a target WTRU for SRSp transmission. A relay WTRU may receive, from a serving gNB (e.g., a first network node), configuration information (e.g., one or more of an SRSp config, a first threshold (e.g., threshold1), and a second threshold (e.g., threshold2) for a target WTRU and a reference TA value (e.g., a first TA value) for the relay WTRU. The relay WTRU may receive the first RSRP measurement(s) made by the target WTRU on RS(s) (e.g., pathloss RS, SSBs), e.g., received from out of coverage (OOC) TRP(s). For example, the first RSRP measurements received from the target WTRU may be associated with the RSRP measurements made by the target WTRU on a per TRP basis on the RS received from each TRP.

The relay WTRU may determine and transmit an initial TA value to the target WTRU, e.g., to be applied with SRSp. The relay WTRU may transmit the SRSp configuration to the target WTRU. The relay WTRU may receive from the target WTRU second RSRP measurement(s) made on RS(s) received from the TRP(s). For example, the second RSRP measurements received from the target WTRU may be associated with the RSRP measurements made by the target WTRU on a per TRP basis on the RS received from each TRP.

If a difference between the second RSRP measurement and the first RSRP measurement is greater than threshold1 and less than or equal to threshold 2 (e.g., threshold2<second RSRP−first RSRP<=threshold2), the relay WTRU may determine and transmit a new TA value (e.g., second TA value) to the target WTRU, e.g., to be applied with SRSp. In examples, when multiple measurement reports are received by the relay WTRU from the target WTRU, where each measurement report received in a single or multiple reporting occasions may be associated with the RSRP measurements made on the RS received from different TRPs, the relay WTRU may transmit to the target WTRU the new TA value (e.g. second TA value) when the RSRP measurements in at least one measurement report satisfies the condition for updating the TA value (e.g., threshold2<second RSRP−first RSRP<=threshold2).

If the difference between the second RSRP measurement and the first RSRP measurement is greater than threshold2 (e.g., second RSRP−first RSRP>threshold2), the relay WTRU may transmit to the target WTRU the indication to release the SRSp configuration. In examples, when multiple measurement reports are received by the relay WTRU from the target WTRU, where each measurement report received in a single or multiple reporting occasions may be associated with the RSRP measurements made on the RS received from different TRPs, the relay WTRU may transmit to the target WTRU the indication to release the SRSp configuration when the RSRP measurements in all measurement reports satisfy the condition for releasing the SRSp configuration (e.g., second RSRP−first RSRP>threshold2).

In examples, techniques may support incremental relay WTRU assisted positioning. A relay WTRU may be configured to be a position delegate for a target WTRU. In examples, the relay WTRU may be configured to act as a position delegate for a target WTRU. The delegation role may include one or more of the following: providing the relay WTRU's (absolute/relative) location to the target WTRU on explicit request from a target WTRU; providing the relay WTRU's location (e.g., absolute/relative location) to the target WTRU on a groupcast/broadcast fashion (e.g., periodically with a configured periodicity); or providing the relay WTRU's absolute location to the target WTRU via dedicated transmitting (e.g., PC5-RRC) and providing (e.g., periodically providing) relative/delta location information via groupcast/broadcast.

In examples, the position delegation registration/association may be controlled by the network (e.g., the network may configure a target WTRU to use a relay WTRU as a position delegate via explicit transmitting towards the target WTRU and relay WTRU).

In examples, the position delegation registration/association may be performed in a peer to peer fashion between the target WTRU and the relay WTRU. In examples, a target WTRU may request a relay WTRU to be a position delegate and/or a relay WTRU may offer (e.g., proactively offer) to become a position delegate to a target WTRU. Such a relationship may be established using a configuration (e.g., pre-configuration) from the network. The configuration may indicate how the association procedure may be performed by the relay WTRU and/or target WTRU.

In examples, the relay WTRU may be configured with different periodicities for broadcasting relative/absolute location information that may be dependent on one or more of the following: current location or location range of the relay WTRU; current mobility state (e.g., speed, direction, acceleration, etc.) of the relay WTRU; number of target WTRUs that are using the relay WTRU as a position delegate; the SL-RSRP/Reference Signal Receive Quality (RSRQ) between the relay WTRU and target WTRU(s); the CBR/CR on the SL between the relay WTRU and target WTRU(s); current time of the day; battery power of the relay WTRU; or requests from target WTRUs (e.g., the target WTRUs may request a periodicity, and the relay WTRU may determine the periodicity of location update frequency towards the target WTRUs using the average, max, minimum, mean, etc., of the requested periodicities).

In examples, the target WTRU may be configured with periodicities. The target WTRU may request location information (e.g., location information may be provided by the delegate relay WTRU in a request-response manner or to indicate periodicity preference during the delegation registration/association with the delegate relay) or acquire location information (e.g., how often to read the location information from the relay WTRUs broadcast/groupcast) that may be dependent on one or more of the following: current location or location range of the target WTRU; current mobility state (e.g., speed, direction, acceleration, etc.) of the target WTRU; the SL-RSRP/RSRQ between the relay WTRU and target WTRU; the CBR/Channel Occupancy Ratio (CR) on the SL; current time of the day; active bearers/application types; traffic level (e.g., buffer status, data rates, etc.); battery power of the target WTRU; or requests from target WTRUs (e.g., the target WTRUs may request a specific periodicity, and the relay WTRU may determine the periodicity of a location update frequency towards the target WTRUs using the average, max, minimum, mean, etc., of the requested periodicities).

In examples, when the target WTRU may be using a relay WTRU as a position delegate, the target WTRU may be configured to not perform any positioning related measurements, measurement reporting and/or positioning determination/calculation by itself. In examples, when the target WTRU is using a relay WTRU as a position delegate, the target WTRU may be configured to perform positioning related measurements and/or positioning determinations/calculations in a relaxed manner (e.g., at a configured periodicity).

In examples, when the target WTRU uses (e.g., starts using) a relay WTRU as a position delegate, one or more of the target WTRU or the relay WTRU may send an indication to the network (e.g., target WTRU sending information about the position delegate, such as relay WTRU identity; relay WTRU sending information about the target WTRU, such the target WTRU identity, etc.).

In examples, when the target WTRU stops using a relay WTRU as a position delegate, one or more of the target WTRU or the relay WTRU may send an indication to the network. The target WTRU may be configured to adapt positioning related behavior based on the current WTRU conditions and conditions of the link between the target WTRU and delegate relay WTRU.

In examples, the target WTRU may be configured to consider the location of the target WTRU to be the same as the location information provided by the delegate relay WTRU, depending on one or more of the following: the SL-RSRP towards the relay WTRU may be above a certain threshold; or the SL-RTT between the target WTRU and relay WTRU may be below a certain threshold.

In examples, the target WTRU may be configured to apply an offset/delta on top of the location information provided by the delegate relay WTRU. The offset/delta to be applied may be, for example, one or more of the following: SL-RSRP (e.g., no offset if SL-RSRP is above threshold1, apply offset1 if SL-RSRP is between threshold1 and threshold 2, apply offset2 if SL-RSRP is between threshold 2 and threshold 3, etc.); or SL-RTT (e.g., no offset if RTT is below threshold1, apply offset1 if RTT is between threshold1 and threshold 2, apply offset2 if RTT is between threshold 2 and threshold 3, etc.).

In an example, the relay WTRU may be configured with an offset/delta configuration, and the relay WTRU (e.g., based on the current SL-RSRP, RTT, etc.) may select the appropriate offset/delta and may send the offset/delta value to the WTRU (e.g., when the location delegation may be provided in a broadcast manner) or (e.g., directly) add the offset/delta value on the location information that the relay WTRU may be sending to the target WTRU (e.g., if the location information may be being delivered to the target WTRU in a dedicated fashion).

In examples, the target WTRU may perform (e.g., start performing) positioning measurements/determinations based on one or more of the SL-RSRP falling below a certain threshold or the SL-RTT becoming more than a certain threshold. If the target WTRU was not configured for positioning measurements, the target WTRU may send a positioning measurement configuration request to the network and/or the relay WTRU.

The target WTRU may perform positioning measurement/determination intermittently (e.g., based on some configured periodicity) as a reference/checkpoint to see if the location provided by the delegate could be considered as valid (e.g., if there is a big difference between own determined location and location provided by the delegate, or the difference is not constant at different times of determination, the WTRU may stop using the position delegate; if the difference is not big or the difference is constant at different times of determination, the WTRU may use the difference as the delta/offset to apply to the location provided by the delegate to find the WTRU's location). In examples, the target WTRU may intermittently or continuously perform the positioning measurement/determination and determine its own location (e.g., the location of the target WTRU) as a combination (e.g., weighted average) of the location that it has determined itself and location provided by the delegate.

In examples, the target WTRU may be configured to stop considering the relay WTRU as a position delegate if the SL-RSRP falls below a certain threshold.

In examples, the target WTRU may be configured to stop considering the relay WTRU as a position delegate if the SL-RTT is above a certain threshold.

In examples, the target WTRU, upon determining to stop using the position delegation of the relay WTRU, may send an indication to the relay WTRU.

In examples, the relay WTRU may determine that it (e.g., the relay WTRU) may not be used as a position delegate for a target WTRU (e.g., via the monitoring of the SL-RSRP, SL-RTT, etc., and comparing them with thresholds).

In examples, the target WTRU may intermittently perform the position determination and compare the location that it (e.g., the target WTRU) may have determined with the location that may have been provided by the delegate relay, and if there is a big difference (e.g., bigger than a configured threshold), the target WTRU may stop using the position delegate.

In examples, the target WTRU, upon a determination that the relay WTRU may no longer be a position delegate (e.g., based on RSRP/RTT thresholds), may start performing positioning measurements for the target WTRU (e.g., based on Uu PRS, based on SL PRS, etc.). If the target WTRU was not configured for positioning measurements, the target WTRU may send a positioning measurement configuration request to the network and/or the relay WTRU.

In examples, the relay WTRU, upon a determination that the relay WTRU may no longer be suitable for position delegation for a target WTRU (e.g., based on own determination, based on indication from the target WTRU, etc.), may send a positioning reference transmissions configuration to the target WTRU and/or start sending positioning reference transmissions to the WTRU and/or indicate to the network to send positioning reference transmissions to the target WTRU.

In examples, one or more of the parameters used for dynamic positioning behavior (e.g., SL-RSRP thresholds, SL-RTT thresholds, offsets/delta values to apply, parameters for weighted average calculation of the WTRU's own determined location and the location provided by the delegate, etc.) may be different for the different positioning technique used (e.g., one set of parameters for e-CID based position determination, one set of parameters for PRS based position determination, etc.)

Although features and elements described above are described in particular combinations, each feature or element may be used alone without the other features and elements of the preferred embodiments, or in various combinations with or without other features and elements.

Although the implementations described herein may consider 3GPP specific protocols, it is understood that the implementations described herein are not restricted to this scenario and may be applicable to other wireless systems. For example, although the solutions described herein consider LTE, LTE-A, New Radio (NR) or 5G specific protocols, it is understood that the solutions described herein are not restricted to this scenario and are applicable to other wireless systems as well.

The processes described above may be implemented in a computer program, software, and/or firmware incorporated in a computer-readable medium for execution by a computer and/or processor. Examples of computer-readable media include, but are not limited to, electronic transmissions (sent over wired and/or wireless connections) and/or computer-readable storage media. Examples of computer-readable storage media include, but are not limited to, a read only memory (ROM), a random access memory (RAM), a register, cache memory, semiconductor memory devices, magnetic media such as, but not limited to, internal hard disks and removable disks, magneto-optical media, and/or optical media such as compact disc (CD)-ROM disks, and/or digital versatile disks (DVDs). A processor in association with software may be used to implement a radio frequency transceiver for use in a WTRU, terminal, base station, RNC, and/or any host computer.

1-14. (canceled)

15. A first wireless transmit/receive unit (WTRU) comprising:
a processor configured to:
receive, from a network node, configuration information indicating a Sounding Reference Signal for positioning (SRSp) configuration associated with a second WTRU, a reference Timing Advance (TA) value associated with the first WTRU, a first threshold value, and a second threshold value;
receive, from the second WTRU, a first RSRP measurement;
determine a first TA value associated with the second WTRU, wherein the determination of the first TA value is based on the first RSRP measurement, the reference TA value, and a measurement associated with the network node; and
transmit, to the second WTRU, the SRSp configuration and the first TA value for the second WTRU.

16. The first WTRU of claim 15, wherein the processor is further configured to:
receive, from the second WTRU, a second RSRP measurement; and
send an indication to the second WTRU based on the first RSRP measurement and the second RSRP measurement.

17. The first WTRU of claim 16, wherein, if a difference between the first RSRP measurement and the second RSRP measurement is between the first threshold value and the second threshold value, the processor is further configured to:
determine a second TA value for the second WTRU to use in association with SRSp transmission, wherein the determination of the second TA value is based on at least the first RSRP measurement, the second RSRP measurement, and the first TA value; and
transmit, to the second WTRU, the indication, wherein the indication indicates the second TA value.

18. The first WTRU of claim 16, wherein if a difference between the first RSRP measurement and the second RSRP measurement is above the second threshold value, the processor is further configured to:
transmit, to second WTRU, the indication, wherein the indication indicates to release the SRSp configuration.

19. The first WTRU of claim 16, wherein the first RSRP measurement is associated with a Transmission Reference Point (TRP), and wherein the second RSRP measurement is associated with the TRP.

20. The first WTRU of claim 15, wherein the first TA value indicates a timing advance associated with SRSp transmission by the second WTRU.

21. The first WTRU of claim 15, wherein the first WTRU comprises a relay WTRU, and wherein the second WTRU comprises a target WTRU.

22. A method for a first wireless transmit/receive unit (WTRU) comprising:
receiving, from a network node, configuration information indicating a Sounding Reference Signal for positioning (SRSp) configuration associated with a second WTRU, a reference Timing Advance (TA) value associated with the first WTRU, a first threshold value, and a second threshold value;
receiving, from the second WTRU, a first RSRP measurement;
determining a first TA value associated with the second WTRU, wherein the determination of the first TA value is based on the first RSRP measurement, the reference TA value, and a measurement associated with the network node; and
transmitting, to the second WTRU, the SRSp configuration and the first TA value for the second WTRU.

23. The method of claim 22, wherein the method further comprises:
receiving, from the second WTRU, a second RSRP measurement; and
sending an indication to the second WTRU based on the first RSRP measurement and the second RSRP measurement.

24. The method of claim 23, wherein, if a difference between the first RSRP measurement and the second RSRP measurement is between the first threshold value and the second threshold value, method further comprises:
determining a second TA value for the second WTRU to use in association with SRSp transmission, wherein the determination of the second TA value is based on at least the first RSRP measurement, the second RSRP measurement, and the first TA value; and
transmitting, to the second WTRU, the indication, wherein the indication indicates the second TA value.

25. The method of claim 23, wherein if a difference between the first RSRP measurement and the second RSRP measurement is above the second threshold value, the method further comprises:
transmitting, to second WTRU, the indication, wherein the indication indicates to release the SRSp configuration.

26. The method of claim 23, wherein the first RSRP measurement is associated with a Transmission Reference Point (TRP), and wherein the second RSRP measurement is associated with the TRP.

27. The method of claim 22, wherein the first TA value indicates a timing advance associated with SRSp transmission by the second WTRU.

28. The method of claim 22, wherein the first WTRU comprises a relay WTRU, and wherein the second WTRU comprises a target WTRU.
